(19) United States
(12) Patent Application Publication
(10) Pub. No.: US 2001/0024305 A1
(43) Pub. Date: Sep. 27, 2001

(54) Optical node device and signal switching and connection method

(76) Inventor: Hiroshi Nishimoto, Kawasaki (JP)

Correspondence Address: STAAS & HALSEY LLP, 700 11TH STREET, NW, SUITE 500, WASHINGTON, DC, 20001, US

(21) Appl. No.: 09/749,426

(22) Filed: Dec. 28, 2000

(30) Foreign Application Priority Data
Mar. 21, 2000 (JP) 2000-078230

(51) Int. Cl. H04J 14/02

(52) U.S. Cl. 359/128; 359/124

(57) ABSTRACT

A switch unit included in one optical node is configured by a plurality of switch circuits having ports the number of which is fewer than that of lines to be accommodated by the switch unit. Since the plurality of switch circuits are mutually independent as sub-switches of the switch unit, the entire switch unit does not become a complete group switch. Accordingly, the line that is accommodated by each of the sub-switches is determined by a service provided to a user accommodated by the line. The switch unit is configured by independent sub-switches as described above, whereby an optical node having a simple configuration can be implemented with small and inexpensive switches. Furthermore, a service provided by the optical node can be easily added by replacing a sub-switch.

### BACKGROUND OF THE INVENTION

1. Field of the Invention

The present invention relates to a system of an optical node such as an optical crossconnect device, etc. for use in a large-capacity optical communications network.

2. Description of the Related Art

In recent years, the capacity of a transmission system quickly becomes large with a rapid increase in communications traffic typified by the Internet. Especially, with the advance of wavelength multiplexing technology, one fiber can make a transmission at several-hundred G bps transmission. In future, the technology for increasing the capacity of a transmission system promises to be further developed. With the increase in the capacity of a wavelength multiplexing transmission system, the demand for implementing a large-capacity optical node system suitable for a wavelength multiplexing transmission system is keen for a configuration of a cost-effective and flexible network of a large capacity.

The large-capacity optical node system that has been conventionally reviewed comprises a (complete group) switch capability for arbitrarily changing connections between all of the input and output ports. As the capabilities of a switch unit, a crossconnect capability, a packet switching capability, a router capability, etc. are under study.

FIGS. 1 and 2 exemplify the fundamental configurations of a conventional crossconnect system.

In FIG. 1, an N×N optical matrix switch is used in a crossconnect system of N inputs and N outputs, and a signal input from any of the input ports can be output to an arbitrary output port.

In the meantime, FIG. 2 shows an example where a complete group electric matrix switch of N inputs and N outputs is used. After an input optical signal is converted into an electric signal by an opto-electric converting circuit, it is switched, connected, and output by the N×N electric matrix switch. The output electric signal is converted into an optical signal by an electro-optic converting circuit, and the optical signal is output.

Currently, many configurations are proposed as the configuration of a crossconnect device. The proposed configurations are broadly classified as follows: a configuration where an optical signal is switched unchanged, and a configuration where opto-electric conversion is performed, and switching is made by an electric circuit.

FIG. 3 exemplifies the fundamental configuration of a conventional optical crossconnect system which makes switching and connection in units of wavelengths.

A transmitting end office multiplexes a plurality of wavelengths with a wavelength multiplexing circuit, and transmits the wavelength-multiplexed signal to an optical fiber transmission line. The optical crossconnect system demultiplexes the received wavelength-multiplexed signal with a wavelength demultiplexing circuit, and inputs the demultiplexed signals to a switch circuit. The switch circuit is also configured by a complete group switch (both optical and electric switches are available). The switched and connected signal is wavelength-multiplexed by a wavelength multiplexing circuit, and transmitted to a receiving end office over an optical fiber transmission line. The receiving end office demultiplexes the wavelength-multiplexed signal with a wavelength-demultiplexing circuit, extracts the information carried on each wavelength, and processes the information.

At present, the practical number of wavelengths of a wavelength multiplexing transmission system is 32. If the number of input/output fibers to/from a crossconnect device is 8, the number of wavelengths input to the crossconnect device results in 32×8=256, on condition that the number of wavelengths per fiber is 32. Consequently, 256×256 crossconnections must be made. The number of multiplexed wavelengths is expected to further increase to 64, 128, etc. Therefore, a crossconnect device of 512×512, 1024×1024, etc. will be required. Nowadays, the highest practical bit rate per wavelength is 10 Gbps, and the capacity input to a crossconnect device is several tera bits or more.

In the meantime, a currently implemented optical matrix switch is approximately 8×8. Therefore, various configurations are proposed to configure a large-scale crossconnect switch such as a configuration where 8×8 switches are combined at a plurality of stages, a broadcasting selection type configuration using a wavelength selection filter, etc. (for example, “Optical Path Cross-connect Node Architectures for Photonic Transport Network”, by S. Okamoto et al., Journal of Lightwave Technology, Vol. 14, No. 6, pp. 1410-1422, 1996). A problem in this case is that the scale of a device becomes very large, and its cost becomes high. This is because many switches and optical parts are required to configure an optical switch unit, and a large number of optical amplifiers for compensating for the losses of optical fibers and optical parts become necessary.

For an electric switching method, the challenges are to implement the installation of several-hundred electric wires without deteriorating the waveform of a high-speed electric signal of 10 Gbps per wavelength, and to implement a large-scale electric matrix switch that operates at high speed.

Additionally, a general idea is that an early stage of introduction of a switch unit starts with a small number of wavelengths, and the number of wavelengths is increased with a future increase in traffic. With the conventional configuration, however, a relatively large-scale switch unit must be comprised from the beginning even if the number of wavelengths at an early stage of introduction is small. Therefore, the scale of the device becomes large, and its cost becomes high even at the early introduction stage where traffic is light. Furthermore, with the conventional configuration, a wavelength must be added even at a later stage under the constraint of the switch configuration and capabilities at the early stage of introduction. Therefore, a new capability keeping abreast with technological advances cannot be introduced.

### SUMMARY OF THE INVENTION

An object of the present invention is to provide an optical node device that has a low-cost and simple configuration, and has high expandability.

An optical node device according to the present invention, which has pluralities of signal inputs and outputs, comprises at least one sub-switch unit, to which some of all of the signals that can be input to the optical node system are input, switches and connects some of all of the signals that can be output from the optical node system, wherein all of the signals input to the optical device are switched and connected by a non-complete group switch that is configured by at least said one sub-switch unit.

A signal switching and connection method according to the present invention is a method for use in an optical node device having pluralities of signal inputs and outputs, comprises the steps of: (a) inputting some of all of signals that can be input to an optical node system; and (b) switching, connecting, and outputting some of all of the signals that can be output from the optical node system, wherein all of the signals are switched and connected as a non-complete group switch by performing the steps (a) and (b) for all of the signals input to the optical node device.

A conventional optical node assumes to use a large complete group switch as a switch unit. However, according to the present invention, a switch unit is implemented as a non-complete group switch composed of at least one sub-switch unit, normally, a plurality of sub-switch units, whereby the required scale of each of the switch units becomes small, and an optical node device having an inexpensive and simple configuration can be provided.

Additionally, the capabilities of an optical node device can be expanded with ease by replacing a sub-switch with a switch having a different capability,

### BRIEF DESCRIPTION OF THE DRAWINGS

FIG. 1 exemplifies the fundamental configuration of a conventional crossconnect system (No. 1);

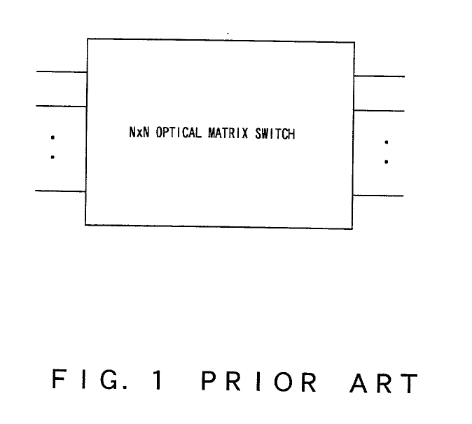

FIG. 2 exemplifies the fundamental configuration of the conventional crossconnect system (No. 2);

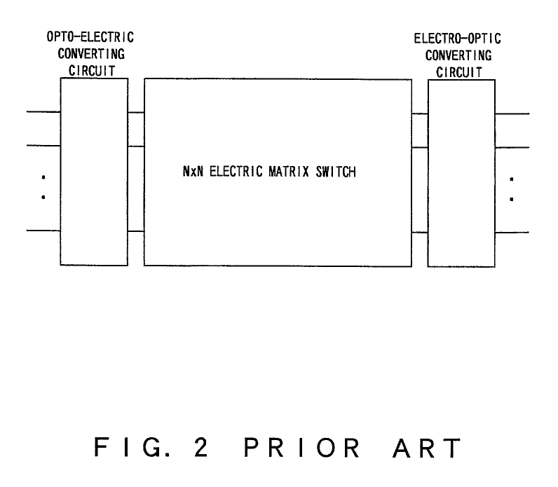

FIG. 3 exemplifies the fundamental configuration of a conventional optical crossconnect system that makes switching and connection in units of wavelengths;

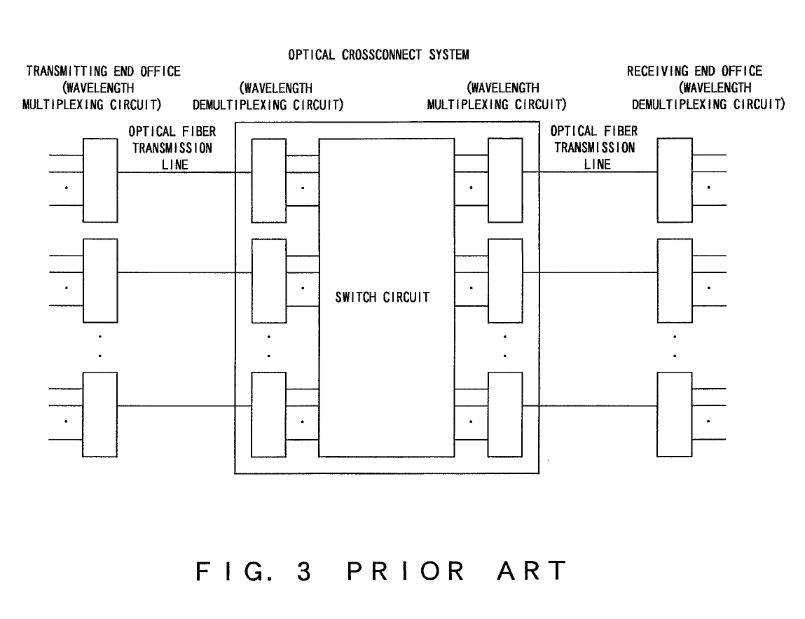

FIG. 4 shows the fundamental configuration of a preferred embodiment according to the present invention (No. 1);

FIG. 5 shows the fundamental configuration of the preferred embodiment according to the present invention (No. 2);

FIG. 6 shows the configuration where sub-switch circuits using electric circuits and sub-switch circuits using optical circuits are mixed and included;

FIG. 7 shows the configuration where electric sub-switch circuits having different capabilities are mixed and included;

FIG. 8 shows the fundamental configuration of the preferred embodiments that are shown in FIGS. 4 through 7 are applied to a wavelength multiplexing system;

FIG. 9 exemplifies the configuration where optical switches are used as sub-switch circuits;

FIG. 10 exemplifies the configuration of modification of FIG. 9, in which the signal-to-noise ratio of an input optical signal is good, and regeneration is made only on an output side;

FIG. 11 exemplifies the details of configuration of the preferred embodiments shown in FIGS. 6 and 7 (No. 1);

FIG. 12 exemplifies the details of the configuration of the preferred embodiments shown in FIGS. 6 and 7 (No. 2);

FIG. 13 shows an example where a sub-switch circuit is added when the number of wavelengths increases (No. 1);

FIG. 14 shows an example where a sub-switch circuit is added when the number of wavelengths increases (No. 2);

FIG. 15 shows an example where a further sub-switch circuit is added when the number of wavelengths increases (No. 3);

FIG. 16 shows the fundamental configuration of a further preferred embodiment according to the present invention (No. 1);

FIG. 17 shows the fundamental configuration of a further preferred embodiment according to the present invention (No. 2);

FIG. 18 shows the configuration where a sub-switch circuit using an electric circuit, and a sub-switch circuit using an optical circuit are mixed and included (No. 1);

FIG. 19 shows the configuration where sub-switch circuits using electric circuits, and sub-switch circuits using optical circuits are mixed and included (No. 2);

FIG. 20 exemplifies the configuration of a system where sub-switch circuits having different capabilities are mixed and included;

FIG. 21 shows an example where the preferred embodiment shown in FIG. 16 is applied to a wavelength multiplexing system;

FIG. 22 shows another example where the preferred embodiment shown in FIG. 16 is applied to a wavelength multiplexing system;

FIG. 23 shows an example where the preferred embodiment shown in FIG. 17 is applied to a wavelength multiplexing system;

FIG. 24 exemplifies the configuration of an optical node where an optical switch circuit is used as a switch circuit;

FIG. 25 exemplifies another configuration where an optical switch circuit is used as a switch circuit;

FIG. 26 exemplifies the details of the configuration of the preferred embodiments shown in FIGS. 16 and 17 (No. 1);

FIG. 27 exemplifies the details of the configuration of the preferred embodiments shown in FIGS. 16 and 17 (No. 2);

FIG. 28 exemplifies the detailed configuration of the preferred embodiments shown in FIGS. 16 and 17 (No. 3);

FIG. 29 shows the fundamental configuration of a still further preferred embodiment according to the present invention (No. 1);

FIG. 30 shows the fundamental configuration of a still further preferred embodiment according to the present invention (No. 2);

FIG. 31 shows the fundamental configuration of a still further preferred embodiment according to the present invention (No. 3);

FIG. 32 shows the fundamental configuration of a still further preferred embodiment according to the present invention (No. 4);

FIG. 33 shows the configuration where a sub-switch circuit which makes switching in units of wavelength-multiplexed signals, and a sub-switch circuit which makes switching in units of wavelengths are mixed and included;

FIG. 34 exemplifies the configuration where a switch unit which makes switching in units of wavelengths or smaller is implemented by a plurality of independent sub-switch circuits;

FIG. 35 exemplifies the configuration where a sub-switch circuit using an electric circuit, and a sub-switch circuit using an optical circuit are mixed and included;

FIG. 36 shows the configuration where a through circuit bypassing some signals without switching them is included (No. 1);

FIG. 37 shows the configuration where a through circuit bypassing some signals without switching them is included (No. 2);

FIG. 38 shows the configuration where through circuits bypassing some signals without switching them is included (No. 3);

FIG. 39 shows the more specific configuration of the preferred embodiments shown in FIGS. 33 through 38 (No. 1);

FIG. 40 shows the more specific configuration of the preferred embodiments shown in FIGS. 33 through 38 (No. 2);

FIG. 41 shows the more specific configuration of the preferred embodiments shown in FIGS. 33 through 38 (No. 3);

FIG. 42 shows the more specific configuration of the preferred embodiments shown in FIGS. 33 through 38 (No. 4);

FIG. 43 shows the fundamental configuration of an optical node according to a still further preferred embodiment of the present invention (No. 1);

FIG. 44 shows the fundamental configuration of an optical node according to a still further preferred embodiment of the present invention (No. 2);

FIG. 45 shows the fundamental configuration of an optical node according to a still further preferred embodiment of the present invention (No. 3);

FIG. 46 shows the fundamental configuration of an optical node according to a still further preferred embodiment of the present invention (No. 4);

FIG. 47 shows an example where the preferred embodiments shown in FIGS. 43 through 46 are applied to a wavelength multiplexing system (No. 1);

FIG. 48 shows the example where the preferred embodiments shown in FIGS. 43 through 46 are applied to a wavelength multiplexing system (No. 2);

FIG. 49 shows an example where the preferred embodiments shown in FIGS. 43 through 46 are applied to a wavelength multiplexing system (No. 3);

FIG. 50 shows an example where the preferred embodiments shown in FIGS. 43 through 46 are applied to a wavelength multiplexing system (No. 4);

FIG. 51 shows an example where the preferred embodiments shown in FIGS. 43 through 46 are applied to a wavelength multiplexing system (No. 5);

FIG. 52 shows an example where the preferred embodiments shown in FIGS. 43 through 46 are applied to a wavelength multiplexing system (No. 6);

FIG. 53 shows an example where the preferred embodiments shown in FIGS. 43 through 46 are applied to a wavelength multiplexing system (No. 7);

FIG. 54 shows an example where the preferred embodiments shown in FIGS. 43 through 46 are applied to a wavelength multiplexing system (No. 8);

FIG. 55 shows an example where the preferred embodiments shown in FIGS. 43 through 46 are applied to a wavelength multiplexing system (No. 9);

FIG. 56 shows the example where the preferred embodiments shown in FIGS. 43 through 46 are applied to a wavelength multiplexing system (No. 10);

FIG. 57 shows the example where the preferred embodiments shown in FIGS. 43 through 46 are applied to a wavelength multiplexing system (No. 11);

FIG. 58 shows the fundamental con figuration of an optical node according to a still further preferred embodiment of the present invention;

FIG. 59 shows the configuration where a circuit switching a wavelength-multiplexed signal in addition to the configuration shown in FIG. 58;

FIG. 60 exemplifies a modification of the configurations shown in FIGS. 58 and 59, in which the switch circuit is configured by a plurality of independent sub-switches (No. 1);

FIG. 61 exemplifies a modification of the configurations shown in FIGS. 58 and 59, in which the switch circuit is configured by a plurality of independent sub-switches (No. 2);

FIG. 62 shows the configuration where a sub-switch circuit using an electric circuit and a sub-switch circuit using an optical circuit are mixed and included (No. 1);

FIG. 63 shows the configuration where a sub-switch circuit using an electric (?) circuit and a sub-switch circuit using an optical circuit are mixed and included (No. 2);

FIG. 64 shows the configuration where switch circuits that are shown in FIG. 63 and performs a switching process in units of wavelength-multiplexed signals are respectively arranged in an input portion and at a middle stage of an optical ADM (No. 1);

FIG. 65 shows the configuration where the switch circuits that are shown in FIG. 63 and perform a switching process in units of wavelength-multiplexed signals are respectively arranged in an input portion and at a middle stage of an optical ADM (No. 2);

FIG. 66 shows an example where the switch circuit is configured by a plurality of independent sub-switch circuits, a distribution switch, and a selection switch;

FIG. 67 exemplifies the configuration of an optical ADM (No. 1); and

FIG. 68 exemplifies the configuration of the optical ADM (No. 2).

### DESCRIPTION OF THE PREFERRED EMBODIMENTS

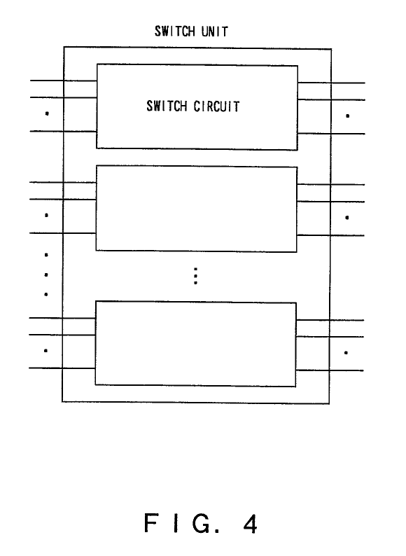

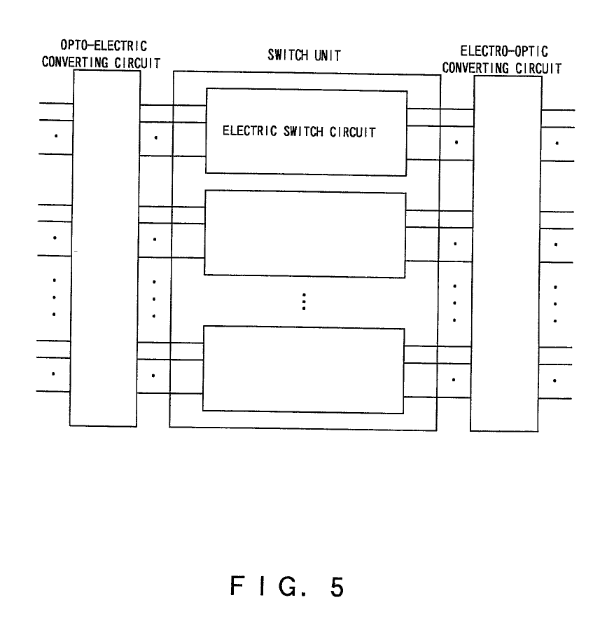

FIGS. 4 and 5 show the fundamental configurations of preferred embodiments according to the present invention.

FIG. 4 shows the case where optical switches are used as switch circuits, whereas FIG. 5 shows the case where electric switches are used as switch circuits. If an electric switch is used, an opto-electric converting circuit for converting an optical signal into an electric signal, and an electro-optic converting circuit for converting an electric signal into an optical signal are arranged.

According to this preferred embodiment, a switch circuit is configured as a divided configuration composed of independent sub-switch circuits, and a sub-switch circuit is added according to an input wavelength. The respective sub-switch circuits are fundamentally independent, and have a crossconnect switch, a packet switch, or a router capability. Since the respective switch circuits are mutually independent, a crossconnect switch that includes these switch circuits as sub-switch circuits does not achieve the capabilities of a complete group switch.

In this configuration, the scale of each sub-switch circuit is small, and a sub-switch circuit can be added according to the number of wavelengths.

Assuming that the numbers of input and output ports of a crossconnect switch are respectively N, the device scale of the switch circuit having the conventional configuration (complete group switch) including the capability for establishing the connections between all of inputs and outputs becomes approximately N×N. If the switch is divided into m sub-switches in the above described configuration according to the present invention, the numbers of inputs and outputs of each sub-switch are respectively N/m. Therefore, the scale of each sub-switch results in (N/m)×(N/m). Because the entire crossconnect switch is configured by m sub-switches of this type, the scale of the crossconnect switch results in (N/m)×(N/m)×m=N×N/m. Consequently, the device scale of the entire crossconnect switch is 1/m of the conventional configuration.

Additionally, since the number of switch circuits can be increased according to the number of wavelengths in this configuration, a cost-effective configuration can be implemented if the number of wavelengths is small. That is, the scalability according to the number of wavelengths can be implemented. Additionally, a switch circuit can be added independently, so that a new capability keeping abreast with technological advances can be introduced into the switch unit composed of switch circuits. Furthermore, because sub-switch circuits are independent, sub-switch circuits having different capabilities can be included to support a wide variety of capabilities.

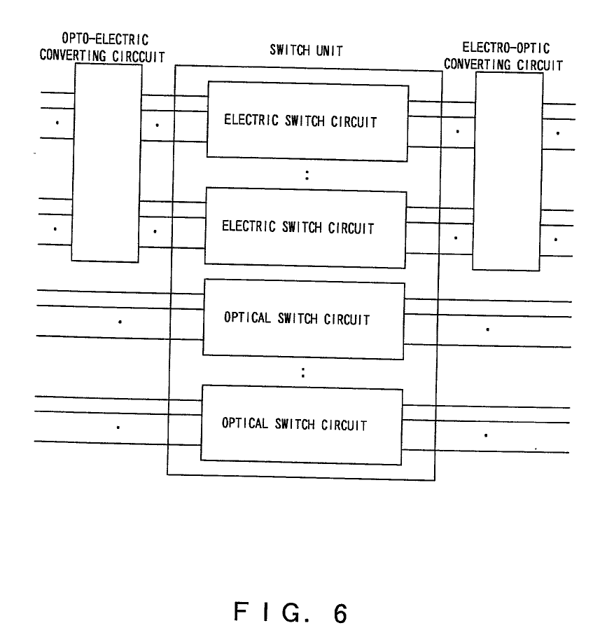

FIG. 6 shows the configuration where sub-switch circuits using electric circuits, and sub-switch circuits using optical circuits are mixed and included.

In this configuration, an optical switch circuit can comprise the capability for making switching in wavelength units (2.4 Gbps, 10 Gbps, etc.) for each cross-connection.

Especially, the optical switch circuit makes switching and connection for each wavelength or for all of multiplexed wavelengths as one chunk, whereas the electric switch circuit can make switching and connection for each channel included in one wavelength in a time-divisional manner. That is, in a wavelength multiplexing optical communication, a plurality of wavelengths are normally multiplexed and transmitted. The information carried on one wavelength is, for example, in a signal format such as an SDH, a SONET format, etc. Accordingly, the electric switch circuit can make switching and connection for each SDH or SONET frame (packet), etc., or in small data units.

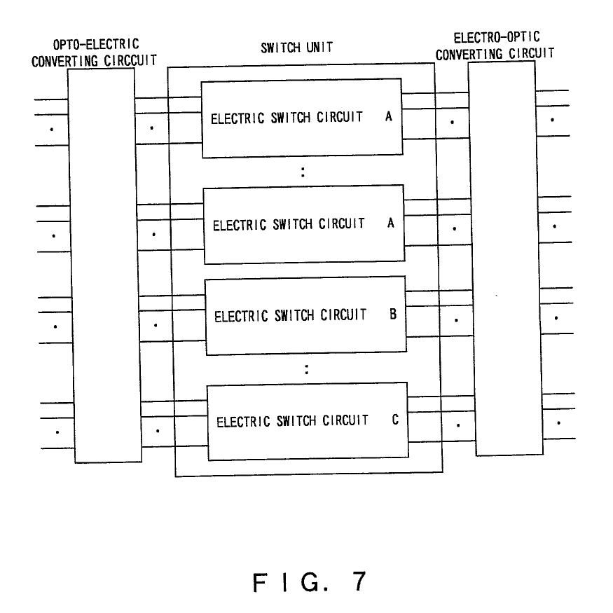

FIG. 7 shows the configuration where electric sub-switch circuits having different capabilities are mixed and included.

For example, an electric switch circuit A shown in FIG. 7 can be configured as a crossconnect switch which makes switching and connection in units of wavelengths of an optical signal converted into an electric signal by an opto-electric converting circuit, an electric switch circuit B can be configured as a switch which makes switching and connection for each frame such as an SDH, a SONET frame, etc. included in each wavelength, and an electric switch circuit C can be configured as a switch which makes switching and connection for each IP packet mapped in an SDH, a SONET frame, etc.

Additionally, as described above, if an optical signal is switched and connected in units of wavelengths, or if the whole of an optical wavelength-multiplexed signal is switched and connected, an optical switch is available.

As stated earlier, according to the preferred embodiment of the present invention, a switch system such as a crossconnect switch system is configured by a plurality of independent sub-switches at the expense of implementing the switch system as a complete group switch, whereby the simplification, downsizing, and ease of expandability of the entire switch system are achieved.

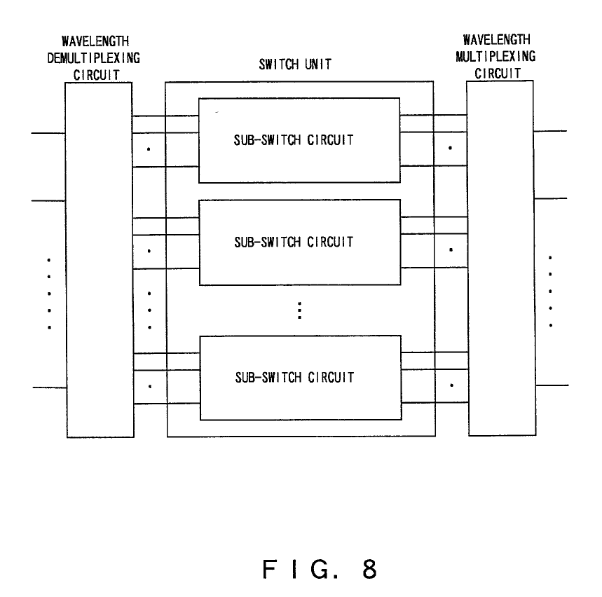

FIG. 8 shows the fundamental configuration of the preferred embodiments that are shown in FIGS. 4 through 7 and are applied to a wavelength multiplexing system.

A plurality of optical fibers which transmit optical wavelength-multiplexed signals are connected to an input portion of a wavelength demultiplexing circuit. The wavelength-multiplexed signal from each of the fibers is demultiplexed into individual optical signals having a single wavelength. The optical signal having the single wavelengths, which are output from the wavelength demultiplexing circuit, are input to one of sub-switch circuits. After the optical signals are switched by the sub-switch circuit, they are wavelength-multiplexed by a wavelength multiplexing circuit and output to an optical fiber transmission line .

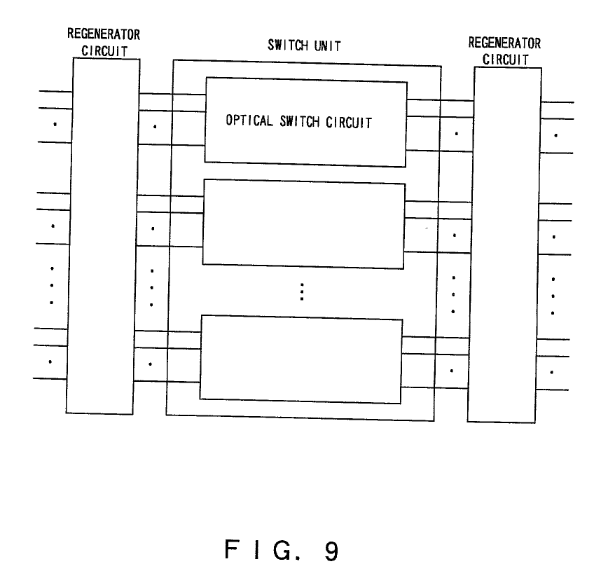

FIG. 9 exemplifies the configuration where optical switches are used as sub-switch circuits.

If an optical signal transmitted over a long distance is input, a regenerator circuit is arranged on an input side to receive and regenerate the optical signal, so that an optical loss caused by a long-distance transmission, and a further deterioration of the signal-to-noise ratio of an optical signal due to the optical loss occurred in an optical switch circuit can be prevented. Furthermore, also on an output side, a regenerator circuit is arranged to regenerate an optical signal, so that the deterioration of the signal-to-noise ratio occurred in an optical switch circuit is compensated for, and the signal is converted into an optical wavelength suitable for a transmission.

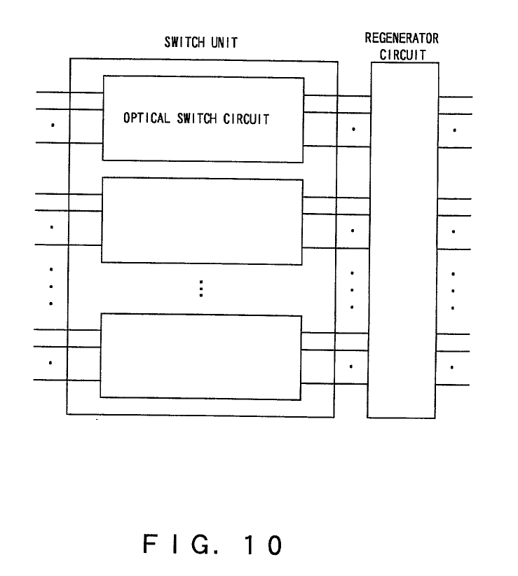

FIG. 10 exemplifies the modification of FIG. 9, which is the configuration where the signal-to-noise ratio of an input optical signal is good, and regeneration is performed only at an output side.

In FIGS. 9 and 10, if an optical switch circuit is used to switch and connect an optical wavelength-multiplexed signal, a wavelength demultiplexing circuit is arranged at a stage preceding a regenerator circuit on an input side, and a wavelength multiplexing circuit is arranged at a stage succeeding a regenerator circuit on an output side. Note that, however, this is the case where an optical switch circuit makes switching and connection in units of wavelengths. The optical switch circuit may also be configured to switch and connect the whole of an optical wavelength-multiplexed signal.

It should be noted that a port which outputs a wavelength-multiplexed signal cannot multiplex identical wavelengths and output to one port. Therefore, an optical transmitting end office which determines the wavelengths of an optical signal output from a switch is made to comprise a wavelength varying function, whereby a more flexible network use, such as a change in a combination of a sub-switch output and an output port which wavelength-multiplexes a signal, can be realized.

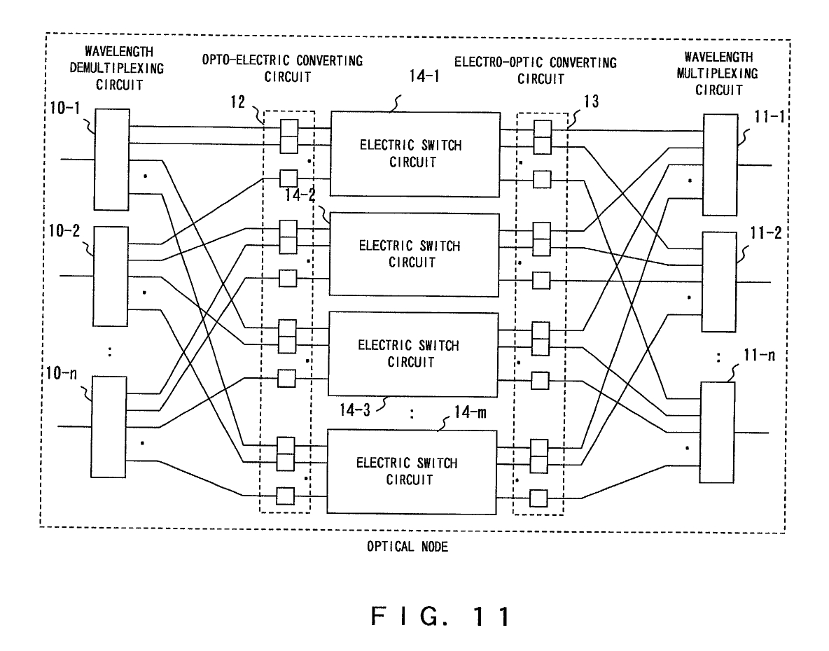

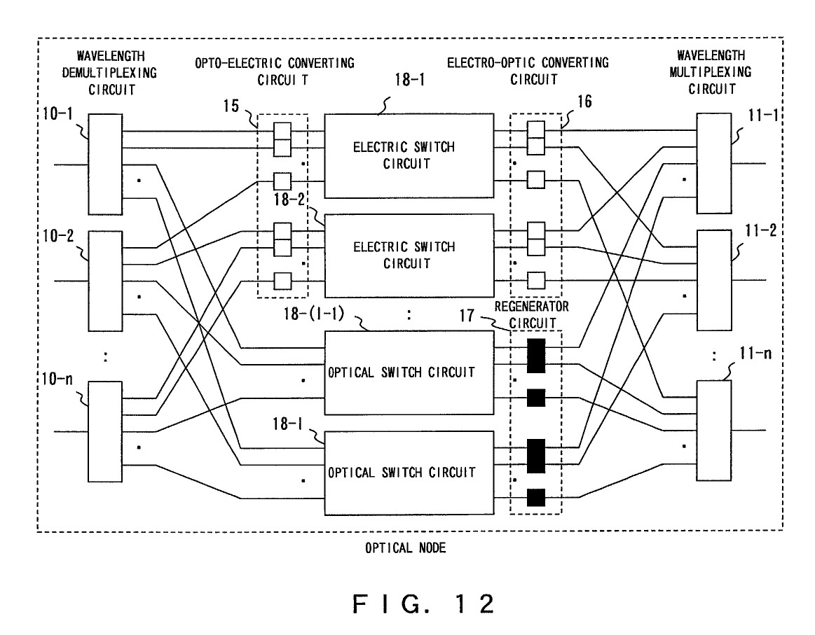

FIGS. 11 and 12 respectively exemplify the details of the configurations according to the preferred embodiments shown in FIGS. 6 and 7.

FIG. 11 exemplifies the configuration where a wavelength multiplexing system and electric switch circuits are combined.

A plurality of optical fibers are connected to the input ports of an optical node, and each of wavelength-multiplexed signals is demultiplexed into signals having a single wavelength by any of wavelength demultiplexing circuits 10-1 through 10-n in the proximity of each input port. The demultiplexed optical signals are converted into electric signals by an opto-eletric converting circuit 12, and the electric signals are connected to one of a plurality of independent electric switch circuits 14-1 through 14-m. Each of the electric switch circuits makes switching and connection between pluralities of input and output signals. A plurality of outputs from each of the electric switch circuits 14-1 through 14-m are respectively converted into optical signals having predetermined wavelengths by an electro-optic converting circuit 13, and the optical signals are connected to one of a plurality of wavelength multiplexing circuits 11-1 through 11-n. A plurality of wavelength-multiplexed signals are output from respective output ports.

Also in this configuration, the respective electric switch circuits 14-1 through 14-m are independent. Therefore, the optical node does not configure a complete group switch. However, the switch scale or the device cost can be significantly reduced.

FIG. 12 exemplifies the configuration of an optical node, in which a wavelength multiplexing transmission system, electric switch circuits, and optical switch circuits are combined.

A plurality of optical fibers which transmit optical wavelength-multiplexed signals are connected to the input ports of an optical node. Each of wavelength-multiplexed signals is demultiplexed into signals having a single wavelength in the proximity of each input port by wavelength demultiplexing circuits 10-1 through 10-n. Some of the demultiplexed optical signals are connected to one of electric switch circuits 18-1 and 18-2 via an opto-electric converting circuit 15. The rest of the optical signals are input to one of optical switch circuits 18-(1-1) and 18-1. Each of the electric switch circuits 18-1 and 18-2 makes switching and connection between pluralities of input and output signals. Each of the electric switch circuits 18-1 and 18-2 can separate a signal having a single wavelength into smaller (lower bit rate) signal units (such as an SDH or a SONET frame, an IP packet or an ATM cell mapped in the frame, etc.), and can make a crossconnection in small signal units. A plurality of outputs from each of the electric switch circuits 18-1 and 18-2 are converted by an electo-optic converting circuit 16 into optical signals having predetermined wavelengths, and the optical signals are connected to one of wavelength multiplexing circuits 11-1 through 11-n. A plurality of wavelength-multiplexed signals are output from respective output ports.

The optical switch circuits 18-(1-1) and 18-1 crossconnect and switch the plurality of input optical signals in units of wavelengths. The optical signals from each of the optical switches are identified and regenerated by a regenerator circuit 17, and output as signals having predetermined wavelengths. The respective output optical signals are input to one of the plurality of wavelength multiplexing circuits 11-1 through 11-n, and multiplexed with the signals from the electric switch circuits 18-1 and 18-2.

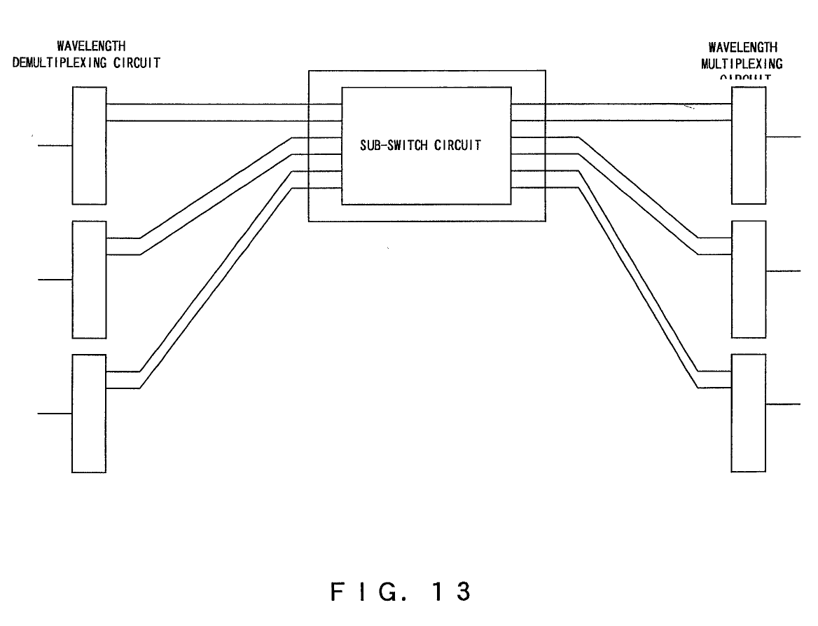

FIGS. 13 through 15 show an example where sub-switch circuits are added when the number of wavelengths increases.

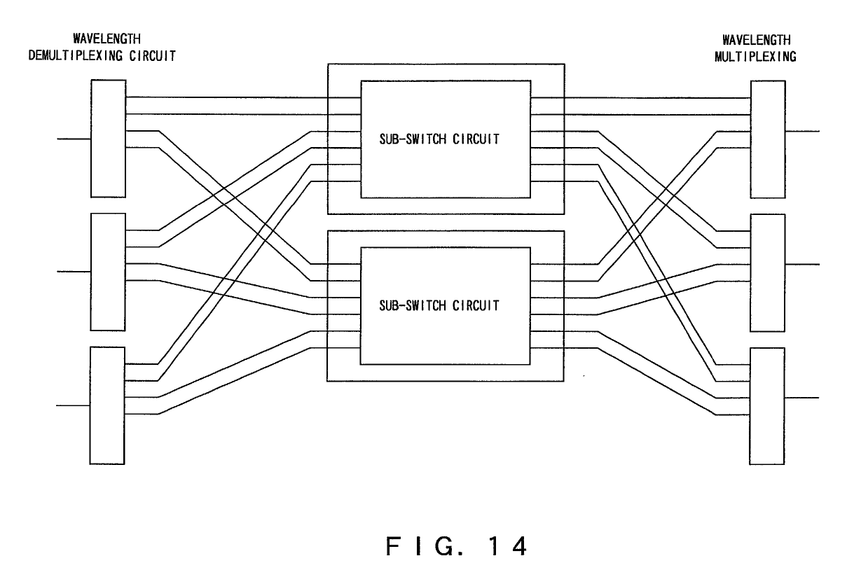

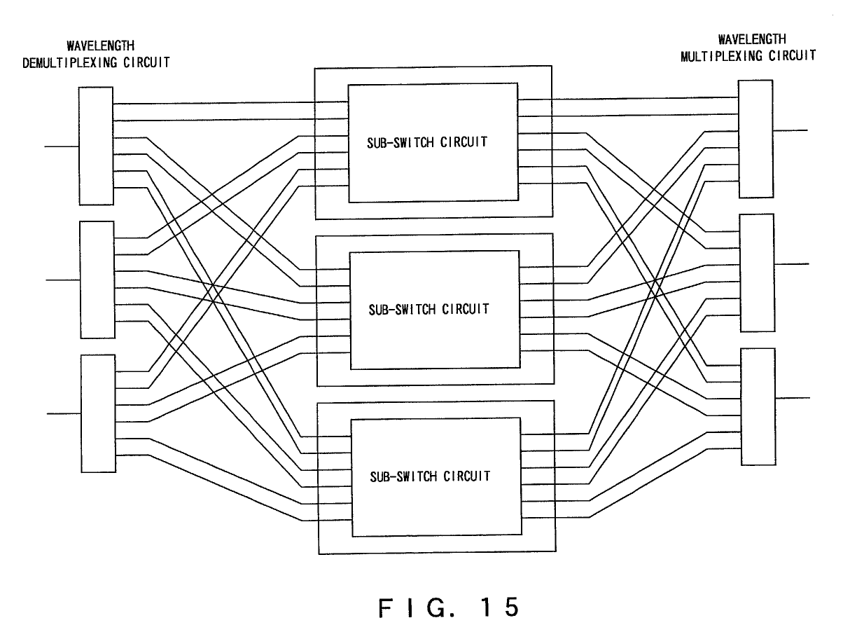

At an early stage where the number of wavelengths is small, a switching process is performed by one sub-switch circuit as shown in FIG. 13. If the number of wavelengths increases, one sub-switch circuit is added as shown in FIG. 14, and the switching process is performed by the two sub-switch circuits. At this time, wiring is carried out to input optical signals having wavelengths to be switched to one sub-switch circuit. Namely, since the sub-switch circuits are mutually independent in this preferred embodiment, the switching and connection between the sub-switch circuits are not made. Therefore, a network administrator determines how to connect the wavelength demultiplexing circuits, the wavelength multiplexing circuits, and the sub-switch circuits by considering which wavelengths transmitted from which lines must be switched and connected together. If the number of wavelengths further increases, one more sub-switch circuit is added as shown in FIG. 15, and the switching and connection are made by the three sub-switch circuits in total. Also in this case, as described above, the network administrator connects the wavelength demultiplexing circuits, the wavelength multiplexing circuits, and the sub-switch circuits by considering which wavelengths to be switched and connected together.

As stated earlier, a required number of sub-switch circuits are added with an increase in the number of wavelengths to be used in a wavelength multiplexing communications network, and the sub-switch circuits are suitably connected to wavelength demultiplexing and multiplexing circuits, thereby eliminating the need for preparing a large-scale switch from an early stage at which the number of wavelengths is small, and adding a sub-switch circuit with ease.

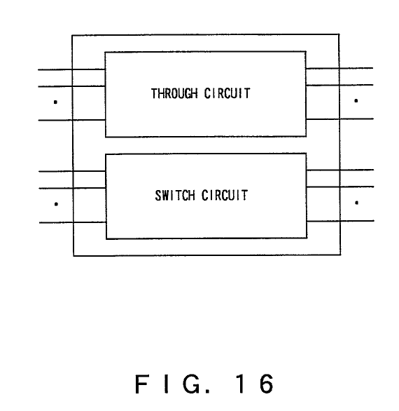

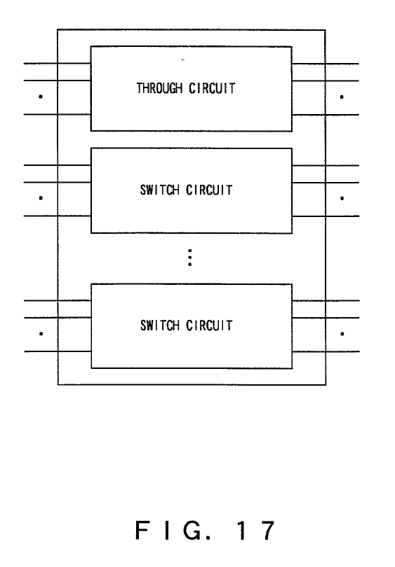

FIGS. 16 and 17 show the fundamental configurations of further preferred embodiments according to the present invention.

FIG. 16 shows the partial switch configuration, where an optical node is configured by a switch circuit and a through circuit, some of input signals are bypassed without being switched, and the other signals are input to the switch circuit and switched.

FIG. 17 shows the configuration of a partial switch and divided switches, in which a through circuit is arranged in an optical node, and switch circuits are implemented by sub-switch circuits.

Here, each of the switches has a function of a crossconnect switch, a packet switch, or a router.

In the configurations shown in FIGS. 16 and 17, signal paths are divided into fixed and variable paths, and path reestablishment required by traffic fluctuations is made by a variable path portion, so that the device scale of the switch unit can be significantly reduced in comparison with the configuration where all paths can be switched. Furthermore, the switch unit is divided into independent sub-switches, leading to a further reduction in the device scale.

If the numbers of inputs and outputs are respectively N, the device scale of the switch unit becomes approximately N×N in the conventional configuration with the capability for establishing the connections between all of the inputs and outputs.

In the meantime, If n among the N inputs are defined to be variable paths and (N-n) inputs are defined to be fixed paths in the configurations shown in FIGS. 16 and 17, the device scale of the switch unit becomes n×n. The device scale of the switch unit in these configurations therefore results in (n×n)/(N×N) of the conventional configuration.

Furthermore, if the switch unit is divided into m sub-switches, the numbers of inputs and outputs of each switch are respectively n/m. The scale of each of the sub-switches therefore becomes (n/m)×(n/m). Since the whole of the switch unit is configured by m sub-switches of this type, its device scale becomes (n/m)×(n/m)×m=n×n/m. Consequently, the device scale of the entire switch unit results in (1/m) (n×n)/(N×N) of the conventional configuration.

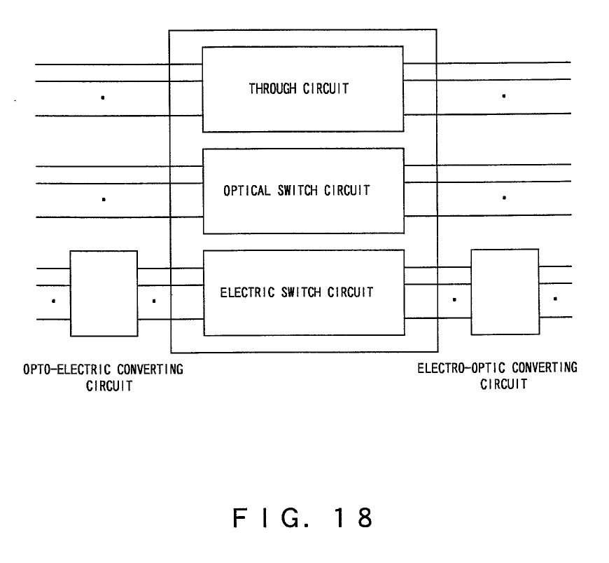

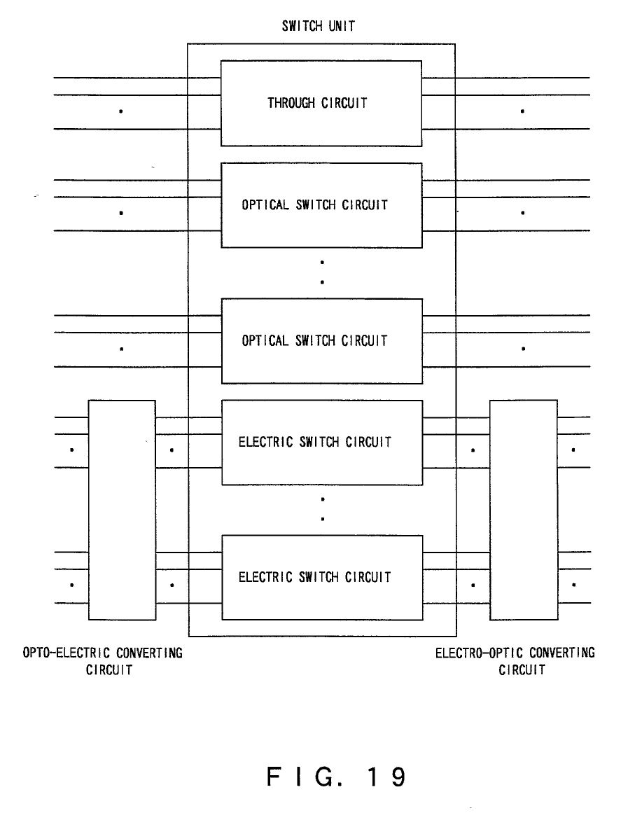

FIGS. 18 and 19 respectively show the configurations where sub-switch circuit(s) using electric circuit(s) and sub-switch circuit(s) using optical circuit(s) are mixed and included.

FIG. 18 shows the configuration of an optical node where one optical switch circuit and one electric switch circuit are included in addition to a through circuit. Notice that wavelength demultiplexing and multiplexing circuits, which are arranged in a wavelength multiplexing communications system, are not illustrated in this figure. Accordingly, FIG. 18 is based on the premise that an optical signal is input as a signal having a single wavelength. The optical node having this configuration is devised based on the idea that there is no need to allow all optical nodes to switch and connect all optical signals if the signals are transmitted with many wavelengths. Accordingly, if a network administrator learns that a wavelength for which switching and connection are not required by a certain optical node when giving attention to the certain optical node, the optical signal having that wavelength is input to a through circuit. The through circuit is normally intended to pass an input optical signal unchanged, although it can include an amplifier for amplifying an optical signal or a regenerator for regenerating an optical signal.

A network administrator configures an optical node so that an optical signal which is required to be switched and connected in units of wavelengths is input to an optical switch circuit. Additionally, if it is necessary to make switching and connection for each data packet carried on one wavelength, the network administrator configures the optical node so that the optical signal having that wavelength is input to an electric switch circuit. For the switching and connection by an electric switch circuit, an optical signal is converted into an electric signal by an opto-electric converting circuit, a frame or a packet is extracted from the electric signal by the electric switch circuit, the electric signal is then converted into an optical signal by an electro-optic converting circuit after being switched and connected, and the optical signal is output.

FIG. 19 shows the modification of the configuration shown in FIG. 18, in which pluralities of optical and electric switch circuits are arranged as sub-switch circuits.

If the number of used wavelengths grows in a wavelength multiplexing communications system, measures are taken in a way such that the number of optical or electric switch circuits being sub-switch circuits is increased, and the sub-switch circuits are suitably connected to lines. Since the switch unit is configured by a plurality of independent switch circuits at this time, it is not implemented as a complete group switch. Therefore, if lines are unsuitably connected, desired switching and connection processes cannot be made. However, these processes can be easily performed if a network administrator considers the contents of a service provided to a user when a sub-switch circuit is added.

FIG. 19 illustrates only one through circuit. This is because independent lines that pass optical signals through are arranged not to cross one another within the through circuit (an optical amplifier or a regenerator may be arranged as a matter of course). Accordingly, there is no substantial difference from the case where a plurality of through circuits are illustrated.

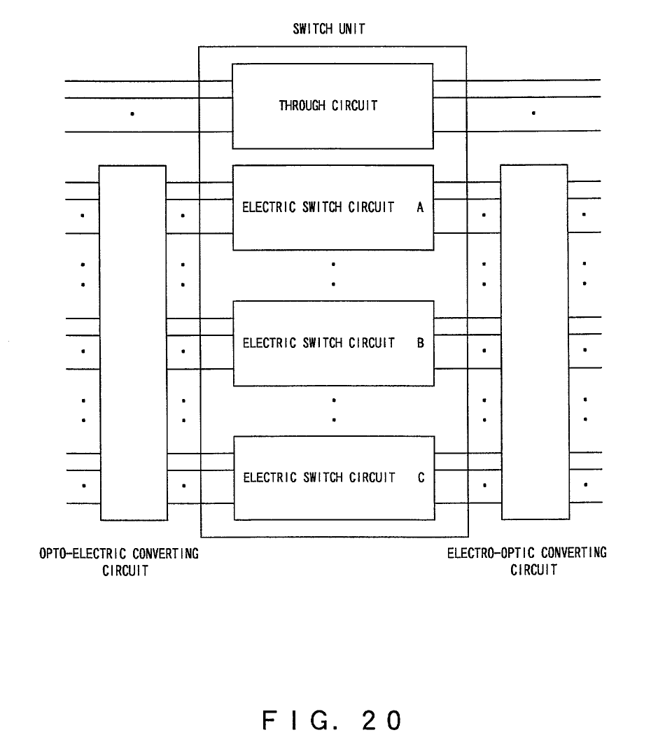

FIG. 20 exemplifies the configuration of the system where sub-switch circuits having different capabilities are mixed and included.

In this figure, for example, an electric switch A can be configured as a crossconnect switch, an electric switch B can be configured as a packet switch, and an electric switch C can be configured as a router. The switch unit is configured by being divided into sub-switch circuits in this way, so that switches of different types can be mixed and included. Namely, a variety of services can be provided by one optical node. Which line is connected to which sub-switch circuit is determined by the contents of the service to be provided to a user accommodated by a connected line.

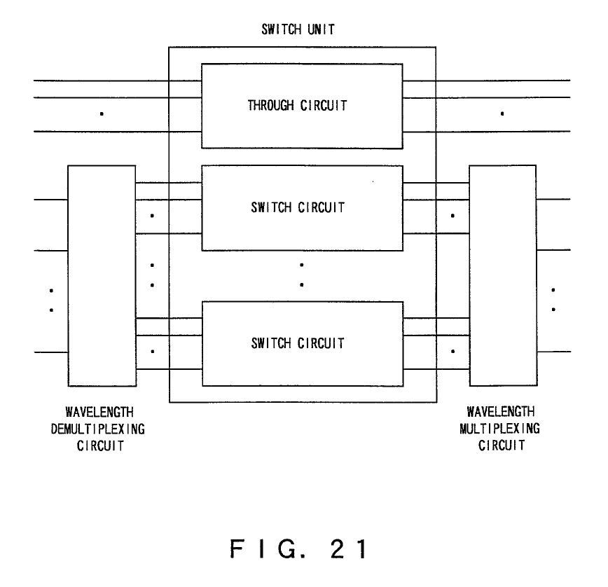

FIG. 21 shows an example where the preferred embodiment shown in FIG. 16 is applied to a wavelength multiplexing system.

The configuration shown in FIG. 21 is an example where through signal units are set as units of wavelength-multiplexed signals. Some of a plurality of wavelength-multiplexed signals are bypassed unchanged via a through circuit, and the rest of the signals are demultiplexed by wavelength demultiplexing circuits into optical signals having a single wavelength, and input to switch circuits. The outputs from the switch circuits are multiplexed by wavelength multiplexing circuits, and output to optical fiber transmission lines.

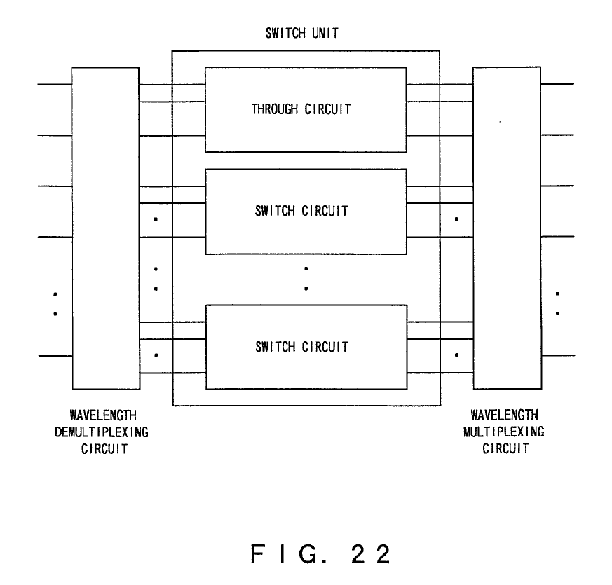

FIG. 22 shows another example where the preferred embodiment shown in FIG. 16 is applied to a wavelength multiplexing system.

In this figure, through signals are set in units of wavelengths. After an input wavelength-multiplexed signal is demultiplexed into signals having a single wavelength via a wavelength demultiplexing circuit, some of the demultiplexed signals are bypassed via a through circuit, and the rest of the signals are switched.

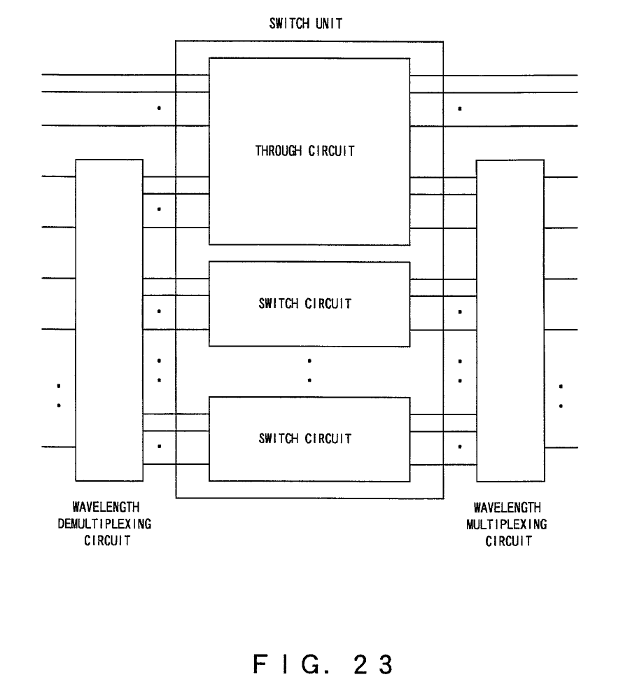

FIG. 23 shows an example where the preferred embodiment shown in FIG. 17 is applied to a wavelength multiplexing system.

This figure exemplifies the configuration of the system where through signals units may be set as the units of either wavelengths or wavelength-multiplexed signals. Namely, optical wavelength-multiplexed signals from some lines are input to a through circuit and output unchanged. Additionally, some of the optical through signals are input to the through circuit after being wavelength-demultiplexed, and output unchanged. These signals are then wavelength-multiplexed and output by wavelength multiplexing circuits. Optical signals are allowed to pass the through circuit in units of wavelengths as described above, thereby coping with the case where some of the wavelengths of one wavelength-multiplexed signal must be switched and connected, but the rest of the wavelengths are not required to be switched and connected.

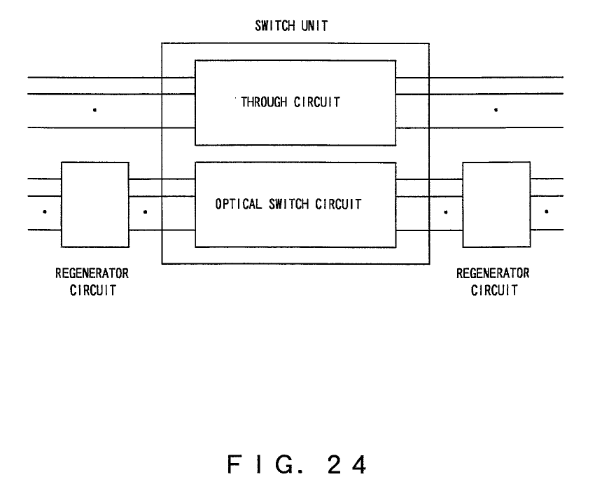

FIG. 24 exemplifies the configuration of an optical node where an optical switch circuit is used as a switch circuit.

If an optical signal transmitted over a long distance is input, it is once received and regenerated by a regenerator circuit before being input to the optical switch circuit so that the deterioration of the signal-to-noise ratio, which is caused by a long-distance transmission, and the further deterioration of the signal-to-noise ratio of the optical signal due to an optical loss occurring in the optical switch circuit can be prevented. Also if an optical signal is output from the optical switch circuit, the signal is regenerated by a regenerator circuit so that the deterioration of the signal-to-noise ratio occurred in the optical switch circuit is compensated for, and the signal is converted into a signal having a wavelength suitable for a transmission.

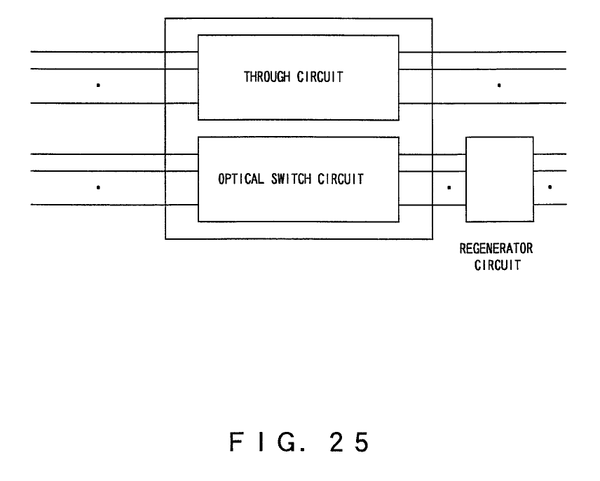

FIG. 25 exemplifies another configuration of the optical node where an optical switch circuit is used as a switch circuit.

This figure shows the configuration where regeneration is made only on an output side in the case where the signal-to-noise ratio of an input optical signal is good.

It should be noted that a port which outputs a wavelength-multiplexed signal cannot multiplex identical wavelengths and output to one port. Therefore, an optical transmitting unit which determines the wavelengths of an optical signal output from a switch is made to comprise a wavelength varying function, whereby a more flexible network use, such as a change in a combination of a sub-switch output and an output port which wavelength-multiplexes a signal, can be realized.

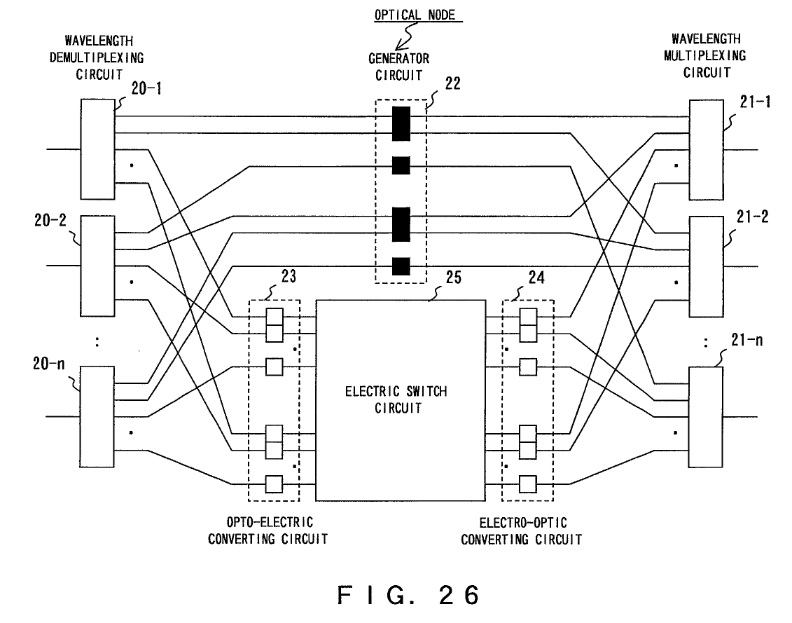

FIGS. 26 through 28 exemplify the details of the configurations of the preferred embodiments shown in FIGS. 16 and 17.

FIG. 26 exemplifies the configuration of an optical node where a wavelength multiplexing system and an electric switch circuit are combined, and through signals are set to be signals in units of wavelengths.

A plurality of optical fibers which transmit optical wavelength-multiplexed signals are connected to the input port of the optical node. A wavelength-multiplexed signal is demultiplexed into signals having a single wavelength by wavelength demultiplexing circuits 20-1 through 20-n in the proximity of each input port. Some of the demultiplexed signals are bypassed via a regenerator circuit 22. The rest of the signals are converted into electric signals by an opto-electric converting circuit 23, and connected to an electric switch circuit 25. In the regenerator circuit 22, the signals are regenerated and their wavelengths are set to be predetermined wavelengths. The electric switch circuit 25 makes the switching and connection between pluralities of input and output signals. A plurality of outputs from the electric switch circuit 25 are converted into optical signals having predetermined wavelengths. The optical outputs from the regenerator circuit 22 and the electro-optic converting circuit 24 are connected to one of a plurality of wavelength multiplexing circuits 21-1 through 21-n. Consequently, a plurality of wavelength-multiplexed signals are output from respective output ports.

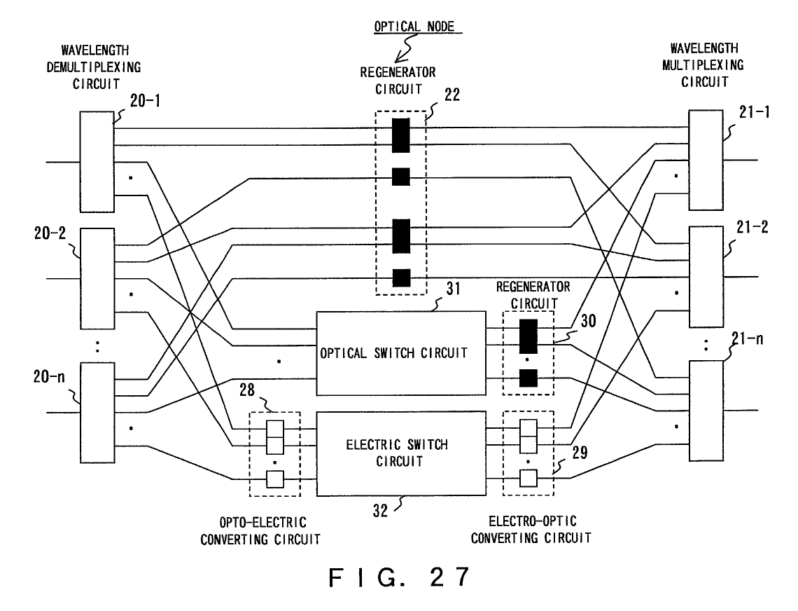

FIG. 27 exemplifies the configuration where a wavelength multiplexing transmission system, an electric switch circuit, and an optical switch circuit are combined, and through signals are set to be signals in units of wavelengths.

A plurality of optical fibers which transmit optical wavelength-multiplexed signals are connected to the input ports of the optical node, and a wavelength-multiplexed signal is demultiplexed into signals having a single wavelength by wavelength demultiplexing circuits 20-1 through 20-n in the proximity of each input port. Some of the demultiplexed signals are bypassed via a regenerator circuit 22, and some of the rest of the signals are connected to an electric switch circuit 32 via an opto-electric converting circuit 28, and the other signals are input to an optical switch circuit 31. The electric switch circuit 32 makes the switching and connection between pluralities of input and output signals. The electric switch circuit 32 can separate a signal having a single wavelength into smaller (lower bit rate) signal units (such as an SDH or a SONET frame, an IP packet or an ATM cell mapped in the frame, etc.), and can make a crossconnection in small signal units. A plurality of outputs from the electric switch circuit 32 are converted into optical signals having predetermined wavelengths by an electro-optic converting circuit 29. In the optical switch circuit 31, the plurality of input optical signals are crossconnected and switched in units of wavelengths. The optical signals from the optical switch circuit 31 are identified and regenerated by a regenerator circuit 30, and output as signals having predetermined wavelengths. The respective optical outputs from the regenerator circuit 30 and the electro-optic converting circuit 29 are input to one of a plurality of wavelength multiplexing circuits 21-1 through 21-n. Consequently, a plurality of signals wavelength-multiplexed with the through signals are output from respective output ports.

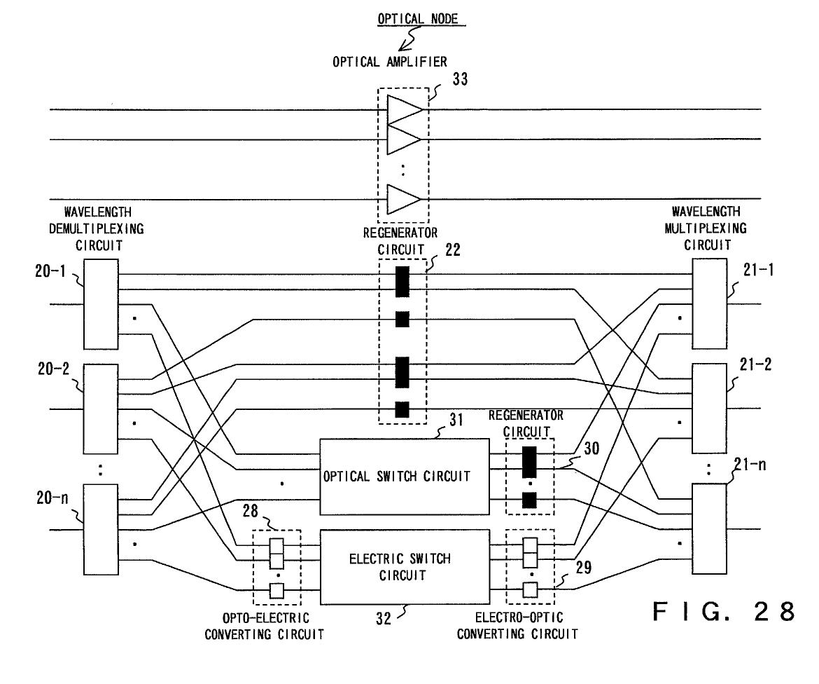

FIG. 28 exemplifies the configuration of a system where a wavelength multiplexing transmission system, an electric switch circuit, and an optical switch circuit are combined, and through signals may be set in units of both wavelength-multiplexed signals and wavelengths.

A plurality of optical fibers which transmit optical wavelength-multiplexed signals are connected to the input port of an optical node. Some of the wavelength-multiplexed signals are connected to bypass ports. The signals are then amplified to be predetermined optical levels, and output by an optical amplifier 33. The rest of the wavelength-multiplexed signals are demultiplexed into signals having a single wavelength by wavelength demultiplexing circuits 20-1 through 20-n. Some of the demultiplexed signals are bypassed via a regenerator circuit 22, some of the rest of the signals are connected to an electric switch circuit 32 via an opto-electric converting circuit 28, and the other signals are input to an optical switch circuit 31. The electric switch circuit 32 makes the switching and connection between pluralities of input and output signals. The electric switch circuit 32 can separate a signal having a single wavelength into smaller (lower bit rate) signal units (such as an SDH or a SONET frame, an IP packet or an ATM cell mapped in the frame, etc.), and makes a crossconnection in small signal units, as described above. A plurality of outputs from the electric switch circuit 32 are converted into optical signals having predetermined wavelengths by an electro-optic converting circuit 29. In the optical switch circuit 31, the plurality of input optical signals are crossconnected and switched in units of wavelengths. The optical outputs from a regenerator circuit 30 and the electro-optic converting circuit 29 are connected to one of a plurality of wavelength multiplexing circuits 21-1 through 21-n. Consequently, a plurality of signals wavelength-multiplexed with the through signals which passed through the regenerator circuit 22 are output from respective output ports.

This configuration can support units of both wavelength-multiplexed signals and wavelengths as through units. Additionally, wavelength or smaller signal units are selectable as switch units, whereby diversified functions can be efficiently implemented.

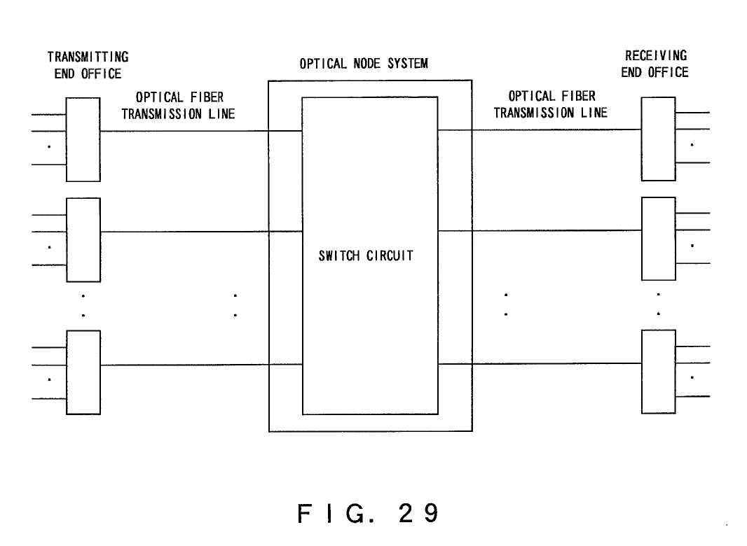

FIGS. 29 through 32 show the fundamental configurations of an optical node according to further preferred embodiments of the present invention.

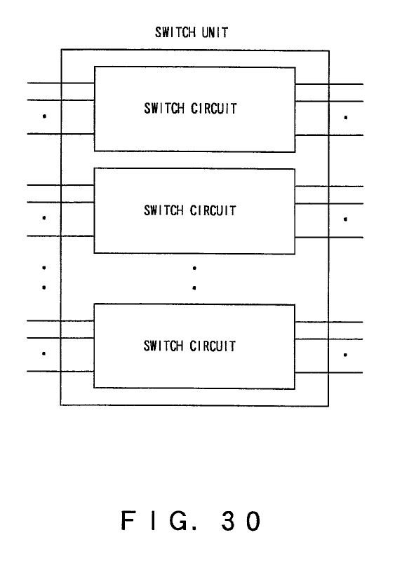

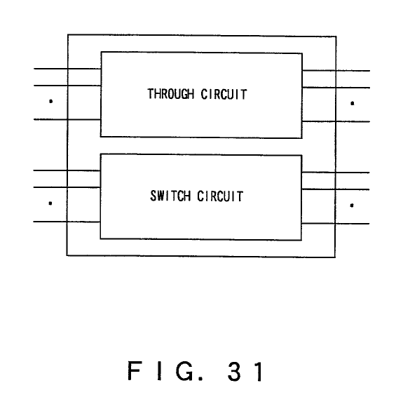

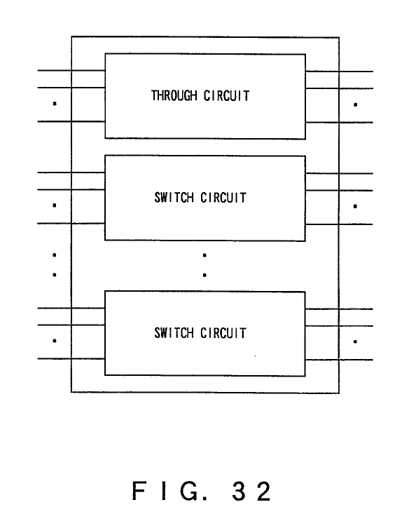

FIG. 29 shows the configuration of a WDM switch that switches a wavelength-multiplexed signal in units of wavelength-multiplexed signals without dimultiplexing the signal into wavelength units. FIG. 30 shows the configuration of a WDM switch and divided switches, in which switch circuits are implemented by a plurality of independent sub-switch circuits. FIG. 31 shows the configuration of a WDM switch and a partial switch, in which some signals are bypassed without being switched. FIG. 32 shows the configuration of a WDM switch, a partial switch, and divided switches, in which some signals are passed through unchanged, and a switch unit is divided.

In the configuration shown in FIG. 29, a wavelength-multiplexed signal transmitted from a transmitting end office is switched not in units of wavelengths but in units of wavelength-multiplexed signals, so that the scale of the switch unit (switch circuit) is significantly reduced in comparison with the case where a signal is switched in units of wavelengths.

Additionally, in the configuration shown in FIG. 30, the switch unit is configured by the plurality of independent switch circuits. Although the switch unit itself is not a complete group switch, the scale of the entire switch unit is reduced. In this case, which line is connected to which switch circuit is determined according to the contents of a service to be provided to a user.

Furthermore, as shown in the configuration shown in FIG. 31, signal paths are classified into fixed and variable paths, which are respectively input to a through circuit and a switch circuit, and path reestablishment required by traffic fluctuations is made by a variable path portion (switch circuit), whereby the scale of the switch unit can be significantly reduced in comparison with the configuration where all paths are switched.

Still further, a switch unit is divided into independent sub-switch circuits as shown in FIG. 32, thereby further reducing the device scale.

Assuming that the numbers of input and output fibers are respectively L, and the number of multiplexed wavelengths per fiber is M, the total numbers of the input and output signals of the switch unit respectively result in LM in the conventional configuration having the capability for establishing the connections between all of inputs and outputs in units of wavelengths. Accordingly, the device scale of the switch unit approximately results in LM×LM.

If all wavelength-multiplexed signals are switched unchanged in the configuration shown in FIG. 29, the scale of the switch unit results in L×L. The device scale of the switch unit in this configuration can be reduced to 1/(M×M) of the conventional configuration. Furthermore, if n among L inputs are defined to be variable paths and (L-n) inputs are defined to be fixed paths as shown in FIG. 31, the device scale of the switch unit results in n×n. The device scale of the switch unit in this configuration can be reduced to (n×n)/(LM×LM) of the conventional configuration.

If the switch unit is divided into m sub-switch circuits as shown in FIG. 32, the numbers of inputs and outputs of each sub-switch circuit respectively result in n/m. Therefore, the scale of each sub-switch circuit becomes (n/m)×(n/m). Since the entire switch unit is configured by m sub-switch circuits, its device scale results in (n/m)×(n/m)×m=n×n/m. Accordingly, the device scale of the entire switch unit can be reduced to (1/m)×(n×n)/(LM×LM) of the conventional configuration.

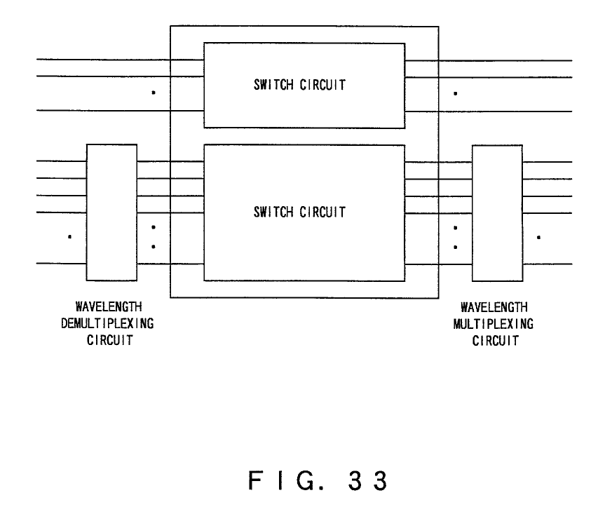

FIG. 33 shows the configuration where a sub-switch circuit which makes switching in units of wavelength-multiplexed signals, and a sub-switch circuit which makes switching in units of wavelengths are mixed and included.

The switch circuit which makes switching in units of wavelength-multiplexed signals and the switch circuit which makes switching in units of wavelengths are arranged in the configuration shown in FIG. 33, so that the traffic for which wavelength demultiplexing is not required can be switched in units of wavelength-multiplexed signals. Accordingly, there is no need to uselessly perform wavelength demultiplexing and multiplexing, contributing to a reduction in the device scale.

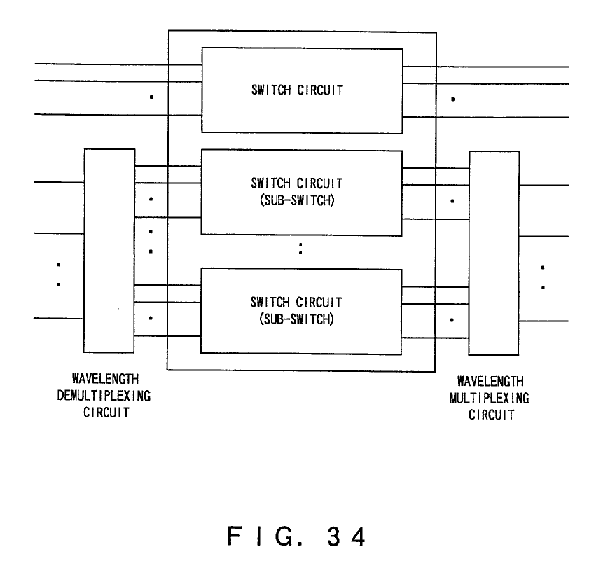

FIG. 34 exemplifies the configuration where a switch unit which makes switching in units of wavelengths or smaller is configured by a plurality of independent sub-switch circuits.

In the configuration shown in FIG. 34, the scale of the switch unit can be reduced by dividing the switch unit into the sub-switch circuits, and the number of sub-switch circuits can be increased according to the number of wavelengths. Therefore, if the number of wavelengths is small, a cost-effective configuration can be implemented and the scalability according to the number of wavelengths can be realized. Additionally, because a sub-switch circuit can be independently added, a new capability keeping abreast with technological advances can be introduced into the sub-switch circuit. Furthermore, since sub-switch circuits are mutually independent, sub-switch circuits having different capabilities can be mixed and included to support a variety of functions.

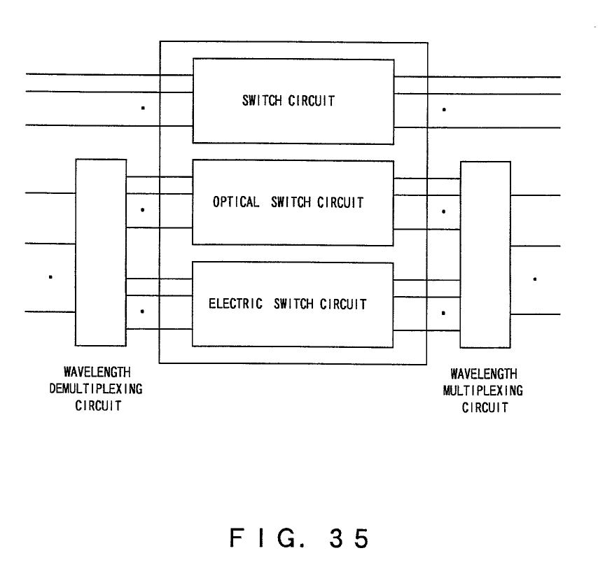

FIG. 35 exemplifies the configuration where a sub-switch circuit using an electric circuit, and a sub-switch circuit using an optical circuit are mixed and included.

With this configuration, the functions for making switching in different crossconnection units can be mixed and included in a way such that the optical switch circuit makes a crossconnection in large units (units of wavelength-multiplexed signals) or in units of wavelengths (2.4 Gbps, 10 Gbps, etc.), whereas the electric switch unit makes a crossconnection in units of wavelengths or smaller (150 Mbps, 600 Mbps, etc.) by performing a demultiplexing process with the electric circuit.

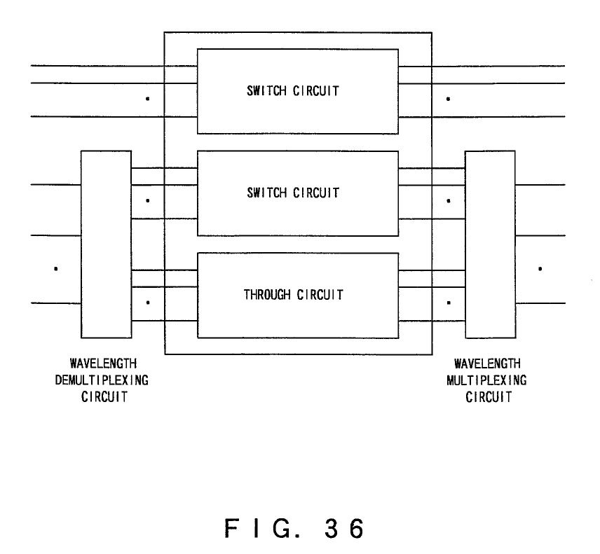

FIGS. 36 through 38 exemplify the configurations where a through circuit which bypasses some signals without making switching.

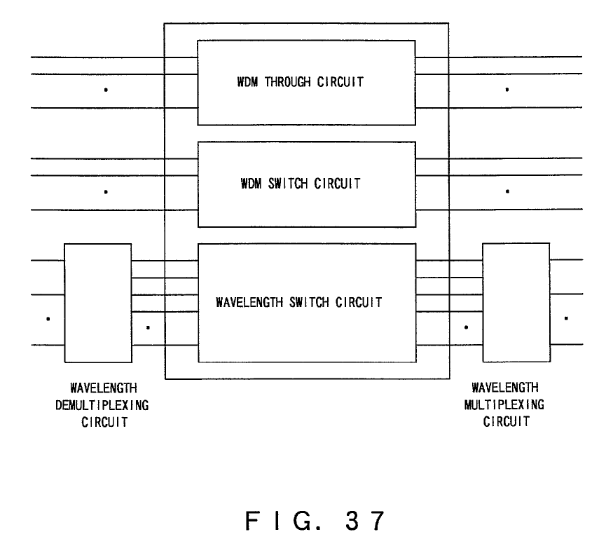

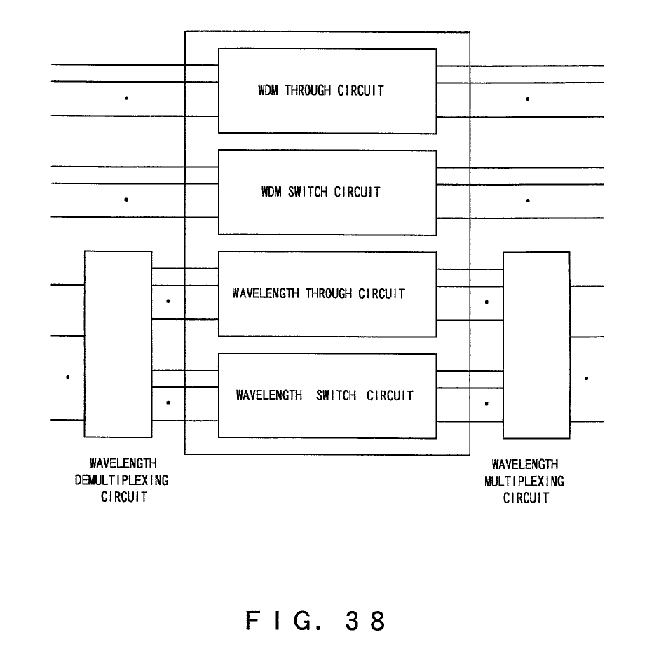

The scale of a switch unit can be reduced by passing some signals through as described above. FIG. 36 shows the configuration where signals are passed through in units of wavelengths. FIG. 37 shows the configuration where signals are passed through in units of wavelength-multiplexed signals. FIG. 38 shows the configuration where through circuits in units of both wavelengths and wavelength-multiplexed signals.

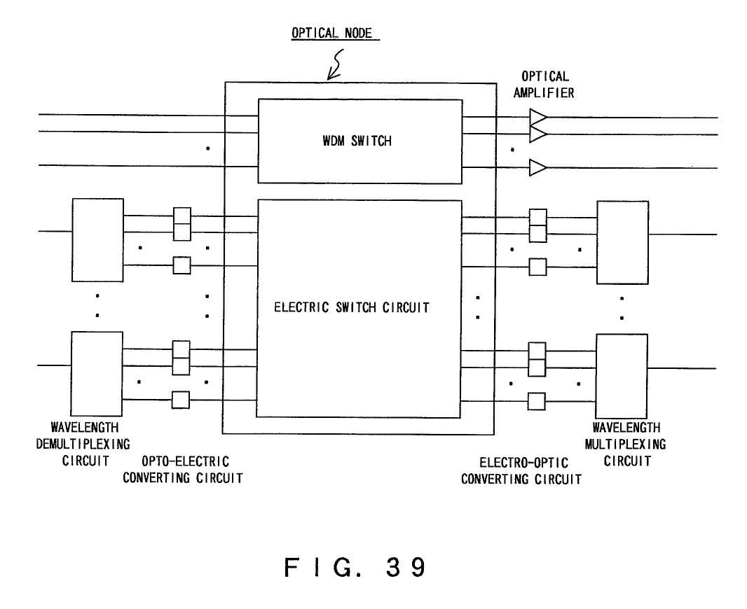

FIGS. 39 through 42 show the more specific configurations of the preferred embodiments shown in FIGS. 33 through 38.

FIG. 39 exemplifies the configuration where an optical switch circuit which makes switching in units of wavelength-multiplexed signals, and an electric switch circuit which makes switching in units of wavelengths or smaller are combined.

A plurality of optical fibers which transmit wavelength-multiplexed signals are connected to the optical node. After the routes of some of the wavelength-multiplexed signals are changed by an optical switch as they are, they are amplified to be predetermined levels and output by an optical amplifier. The rest of the wavelength-multiplexed signals are demultiplexed in units of wavelengths by wavelength demultiplexing circuits. The demultiplexed signals are connected to an electric switch circuit via an opto-electric converting circuit. The electric switch circuit makes the switching and connection between pluralities of input and output signals. The plurality of outputs from the electric switch circuit are respectively converted into optical signals having predetermined wavelengths by an electro-optic converting circuit. The respective optical outputs from the electro-optic converting circuit are connected to one of a plurality of wavelength multiplexing circuits, and a plurality of wavelength-multiplexed signals are output from respective output ports.

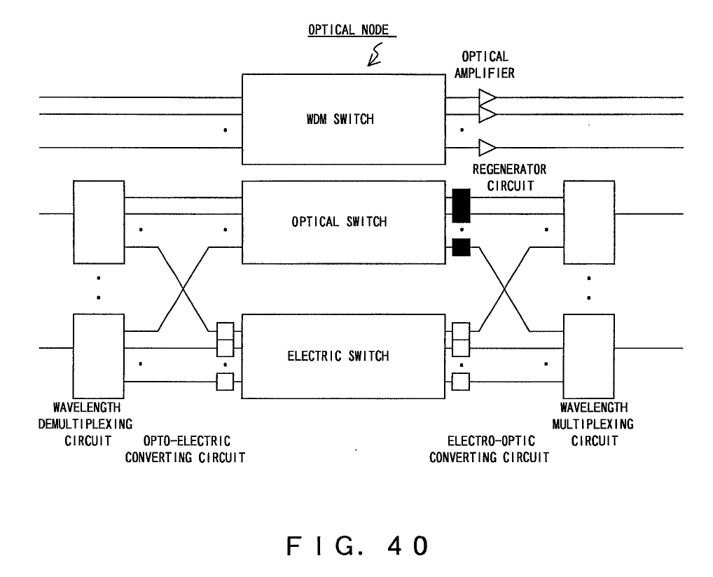

FIG. 40 exemplifies the configuration where an optical switch circuit which makes switching in units of wavelength-multiplexed signals, an optical switch circuit which makes switching in units of wavelengths, and an electric switch circuit which makes switching in units of wavelengths or smaller are combined.

A plurality of optical fibers which transmit wavelength-multiplexed signals are connected to the optical node. After the routes of some wavelength-multiplexed signals are changed by a WDM switch as they are, they are amplified to be predetermined levels and output by an optical amplifier. Some of the demultiplexed signals are input to the optical switch circuit, which crossconnects and switches the input signals in units of wavelengths. The optical signals output from the optical switch are identified and regenerated by a regenerator circuit, and output as signals having predetermined wavelengths. Some of the optical signals are connected to the electric switch circuit via an opto-electric converting circuit. The electric switch circuit makes the switching and connection between pluralities of input and output signals. The electric switch circuit can also separate a signal having a single wavelength into units of smaller (lower bit rate) signals, and can make a crossconnection in small signal units. The plurality of outputs from the electric switch circuit are respectively converted into optical signals having predetermined wavelengths by an electro-optic converting circuit. The optical outputs from the regenerator circuit and the electro-optic converting circuit are connected to one of a plurality of wavelength multiplexing circuits, and a plurality of wavelength-multiplexed signals are output from respective output ports.

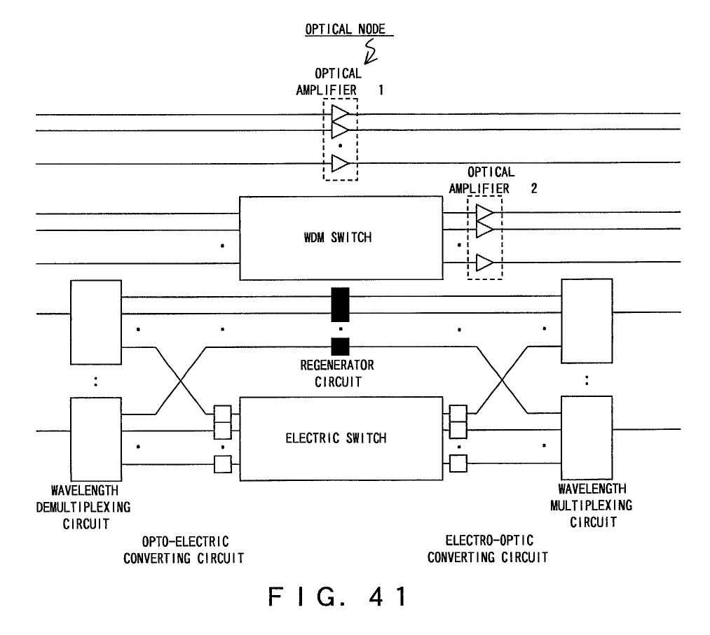

FIG. 41 exemplifies the configuration where a switch circuit which makes switching in units of wavelength-multiplexed signal, and a switch circuit which makes switching in units of wavelengths or smaller are combined. In this configuration, through signals may be set in units of both wavelength-multiplexed signals and wavelengths.

A plurality of optical fibers which transmit optical wavelength-multiplexed signals are connected to the optical node. Some of the wavelength-multiplexed signals are connected to bypass ports, and amplified to be predetermined optical levels and output by an optical amplifier 1.

After the routes of some of the wavelength-multiplexed signals are changed by the optical switch as they are, they are amplified to be predetermined levels and output by an optical amplifier 2. The rest of the wavelength-multiplexed signals are demultiplexed in units of wavelengths by wavelength demultiplexing circuits. Some of the demultiplexed signals are bypassed via a regenerator circuit, some of the rest of the signals are connected to the electric switch via an opto-electric converting circuit. The electric switch circuit makes the switching and connection between pluralities of input and output signals. A plurality of outputs from the electric switch circuit are converted into optical signals having predetermined wavelengths by an electro-optic converting circuit. The respective optical outputs from the regenerator circuit and the electro-optic converting circuit are connected to one of a plurality of wavelength multiplexing circuits, and a plurality of wavelength-multiplexed signals are output from respective output ports.

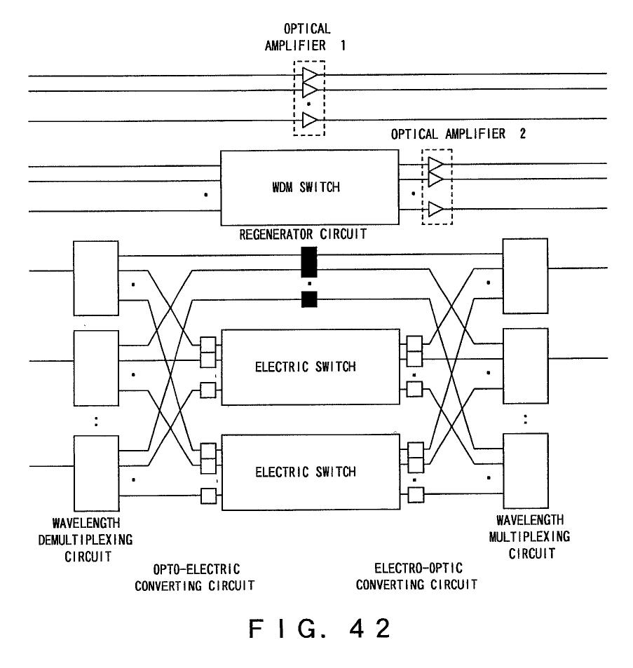

FIG. 42 exemplifies the configuration where the electric switch unit shown in FIG. 41 is configured by a plurality of independent sub-switches.

With this configuration, it becomes possible to reduce the device scale of an electric switch unit, to ensure scalability, and to mix and include switches having different functions.

This configuration is the same as that shown in FIG. 41 except that the electric switch is configured by a plurality of sub-switches. The sub-switches are mutually independent, and switch and connect an electric signal into which an optical signal is converted. It is possible to set SDH or SONET frames, IP packets, or ATM cells, which are carried in one wavelength, as the units of switching and connection. Since the electric switch is configured by the sub-switches, the scale of the electric switch can be reduced although the whole of the switch does not become a complete group switch. Which line is connected to which sub-switch is determined by the contents of a service to be provided to a user accommodated by a connected line.

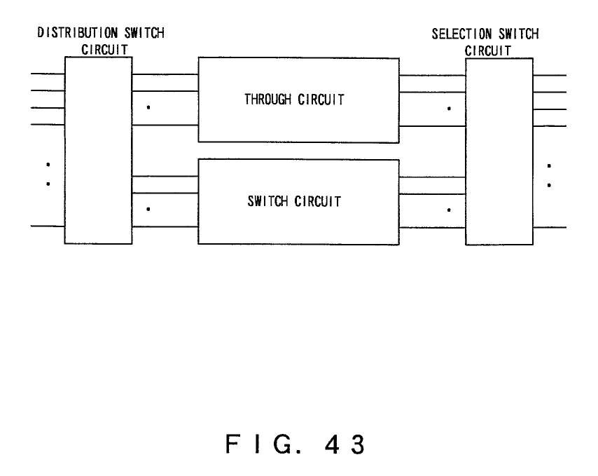

FIGS. 43 through 46 show the fundamental configurations of an optical node according to further preferred embodiments of the present invention.

FIG. 43 shows the partial switch configuration where the optical node is composed of a switch circuit and a through circuit, and some of input signals are bypassed without being switched, and the rest of the signals are input to the switch circuit and switched. This optical node further comprises the switch functions (distribution switch and selection switch circuits) for distributing input signals to the through and the switch circuits.

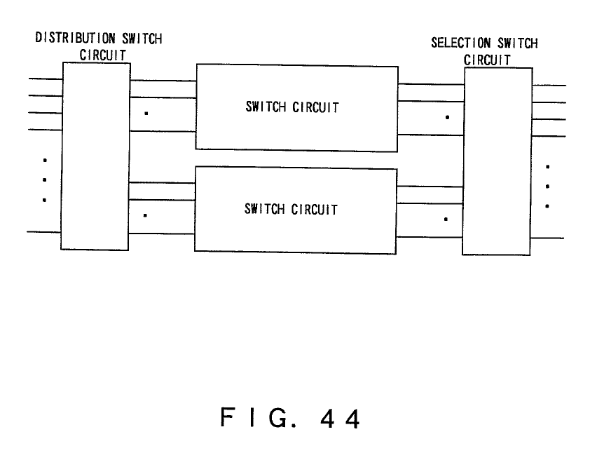

FIG. 44 shows the divided switch configuration where a switch unit is composed of a plurality of independent sub-switches, and the switch functions (distribution switch and selection switch circuits) for distributing input signals to suitable sub-switch circuits are further included.

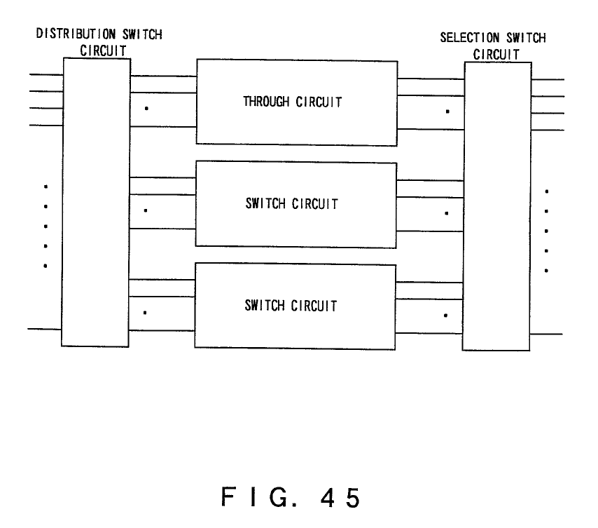

FIG. 45 shows the configuration of an optical node, in which a through circuit is arranged, and switch circuits (a partial switch and a divided switch) are configured by independent sub-switch circuits. This configuration further includes the switch functions (a distribution switch and a selection switch circuit) for distributing signals to either the through circuit or either of the sub-switch circuits.

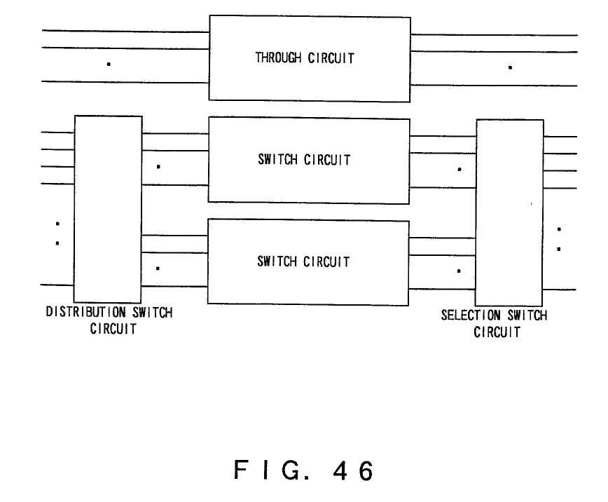

FIG. 46 shows the configuration of an optical node, in which a through circuit is arranged, and switch circuits (a partial switch and a divided switch) are implemented by independent sub-switch circuits. In this configuration, some of input signals are input to the through circuit not via the switches, and the others are distributed to either of the sub-switch circuits by the distribution switch. Here, the switch circuits have a function such as a crossconnect switch, a packet switch, a router, etc.

In the configurations shown in FIGS. 43 through 46, signal paths are classified into fixed and variable paths, and path reestablishment required by traffic fluctuations is made by a variable path portion (switch circuit), so that the device scale of the switch unit is significantly reduced in comparison with the configuration where all paths can be switched. The device scale can be further reduced by dividing the switch unit into independent sub-switches. Furthermore, the process of each input signal can be arbitrarily selected and changed by arranging a distribution switch in an input portion, and a selection switch in an output portion.

If the numbers of inputs and outputs are respectively N, the device scale of a switch unit becomes approximately N×N in the conventional configuration comprising the function for establishing the connections between all of inputs and outputs.

In the above described configurations according to the present invention, the scale of a switch unit becomes n×n if n among the N inputs are defined to be variable paths, and (N-n) inputs are defined to be fixed paths. The device scale of the switch unit in these configurations is (n×n)/(N×N) of the conventional configuration.

Furthermore, if the switch unit is divided into m sub-switches, the numbers of inputs and outputs of each switch are respectively n/m. The scale of each sub-switch therefore becomes (n/m)×(n/m). Since the entire switch unit is configured by m sub-switches of this type, the entire switch unit becomes (n/m)×(n/m)×m=n×n/m. Accordingly, the device scale of the entire switch results in (1/m)(n×n)/(N×N) of the conventional configuration.

Since the number of sub-switches can be increased according to the number of wavelengths in the above described configurations, a cost-effective configuration can be adopted if the number of wavelengths is small. Namely, the scalability can be realized according to the number of wavelengths. Additionally, because the switch unit can be independently expanded, a new capability keeping abreast with technological advances can be introduced into the switch unit. Furthermore, since sub-switch circuits are mutually independent, sub-switch circuits having different functions can be mixed and included to support a wide variety of functions.

In the configuration where a sub-switch circuit using an electric circuit and a sub-switch circuit using an optical circuit are mixed and included, the functions for making switching in different crossconnection units can be mixed and included in a way such that the optical switch circuit makes a crossconnection in units of wavelengths (2.4 Gbps, 10 Gbps, etc.), whereas the electric switch unit makes a crossconnection in units (150 Mbps, 600 Mbps, etc.) smaller than wavelengths by performing a demultiplexing process with the electric circuit.

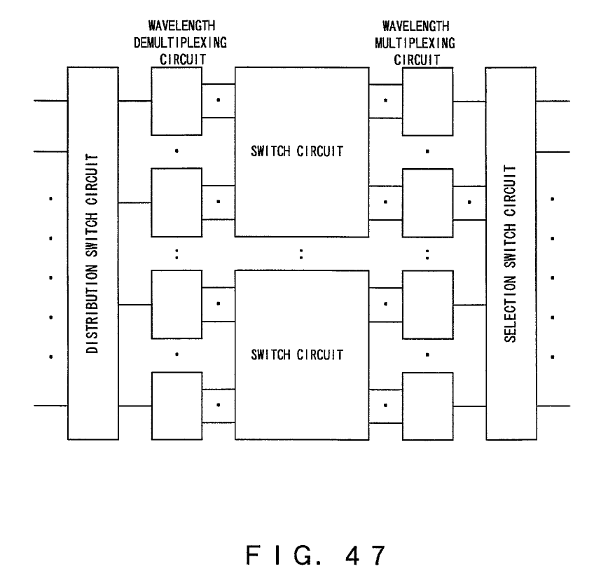

Preferred embodiments shown in FIGS. 47 through 57 respectively show the examples where the preferred embodiments shown in FIGS. 43 through 46 are applied to a wavelength multiplexing system. As distribution units, large units of such as wavelength-multiplexed signals, units (such as SDH or SONET frames, IP packets, ATM cells, etc.) of wavelengths or smaller are considered. Also as the units of a switched signal, units of wavelength-multiplexed signals, wavelengths, and further smaller implemented by an electric circuit can be considered. Diversified configurations can be implemented by combining a through circuit and a divided switch, and an optimum configuration may differ depending on the function and performance required for an optical node. Examples of principal configurations are provided below.

FIG. 47 shows an example where the units of distribution to sub-switches are wavelength-multiplexed signals, and switching units are wavelengths or smaller.

In the configuration shown in FIG. 47, a plurality of wavelength-multiplexed signals are input to a distribution switch circuit. One of the plurality of wavelength-multiplexed signals is input by the distribution circuit to one of a plurality of wavelength demultiplexing circuits. The wavelength demultiplexing circuit demultiplexes the input signal into signals having a single wavelength, and inputs the demultiplexed signals to a switch circuit. The switch circuit switches, connects, and outputs the input signals having the single wavelengths. The signals output from the switch circuit are input to one of a plurality of wavelength multiplexing circuits, wavelength-multiplexed with signals having other wavelengths, and input to a selection switch circuit. The wavelength-multiplexed signal generated by the wavelength multiplexing circuit is switched and output by the selection switch circuit, and output to one line.

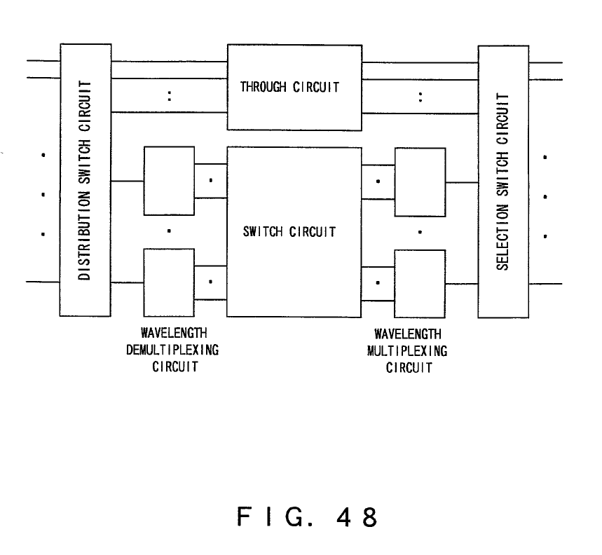

FIG. 48 exemplifies the configuration where distribution units are wavelength-multiplexed signals, through units are wavelength-multiplexed signals, and switching units are wavelengths or smaller.

In this figure, a plurality of wavelength-multiplexed signals are input to a distribution switch circuit via a plurality of lines. The distribution switch circuit distributes the signals to a through circuit and a switch circuit in units of wavelength-multiplexed signals. The wavelength-multiplexed signals input to the through circuit are only amplified or regenerated by an amplifier or a regenerator included in the through circuit without being switched and connected, and input to a selection switch circuit. In the meantime, the wavelength-multiplexed signals distributed to the switch circuit by the distribution switch circuit are demultiplexed into signals having a single wavelength by a wavelength demultiplexing circuit, and input to a switch circuit. The signals input to the switch circuit are switched and connected by the switch circuit, and input to a wavelength multiplexing circuit. The input signals are wavelength-multiplexed by the wavelength multiplexing circuit, and input to a selection switch circuit as a wavelength-multiplexed signal. The selection switch circuit switches and outputs the wavelength-multiplexed signals from the through circuit and the wavelength-multiplexing circuits, and transmits the signals to suitable lines.

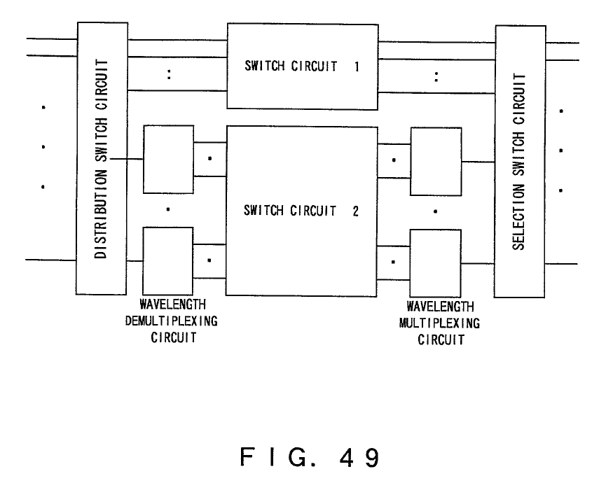

FIG. 49 exemplifies the configuration where distribution units are wavelength-multiplexed signals, and a switch circuit which makes switching in units of wavelength-multiplexed signal, and a switch unit which makes switching in units of wavelengths or smaller are included.

In this figure, wavelength-multiplexed signals are input to a distribution switch circuit via a plurality of lines, and distributed as signals to be switched in units of wavelength-multiplexed signals, and as signals to be switched in units of wavelengths. The signals to be switched in units of wavelength-multiplexed signals are input to a switch circuit 1 unchanged, switched and connected by the switch circuit 1, and output to a selection switch circuit. In the meantime, the signals to be switched in units of wavelengths are input to wavelength demultiplexing circuits, which demultiplex the input signals into signals having a single wavelength. The signals having the single wavelength are input to a switch circuit 2, and switched and connected. After these signals are switched and connected, they are wavelength-multiplexed by a wavelength multiplexing circuit and input to a selection switch circuit. The selection switch circuit switches the wavelength-multiplexed signals from the switch circuit 1 and the wavelength multiplexing circuits, and outputs the signals to suitable lines.

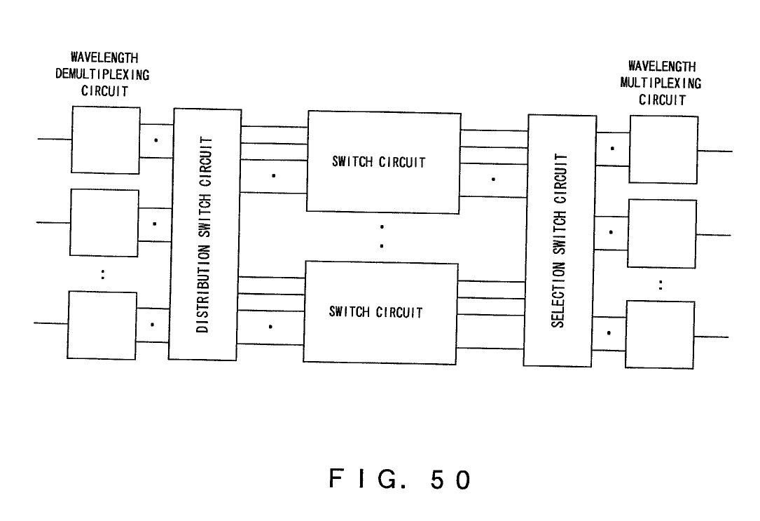

FIG. 50 exemplifies the configuration where distribution units are wavelengths or smaller, and a plurality of independent sub-switches are included.

In this figure, wavelength-multiplexed signals transmitted over a plurality of lines are demultiplexed into signals having a single wavelength by wavelength demultiplexing circuits. Then, a distribution circuit determines to which switch circuits the signals are to be input, and switches and outputs the signals. The plurality of switch circuits switch and connect the input signals having a single wavelength, and outputs the signals to a selection switch circuit. The selection switch circuit switches and outputs the signals having a single wavelength after switching and connecting the signals, and inputs the signals to wavelength multiplexing circuits. The wavelength multiplexing circuits wavelength-multiplex the input signals having a single wavelength, and output the wavelength-multiplexed signals to respective lines.

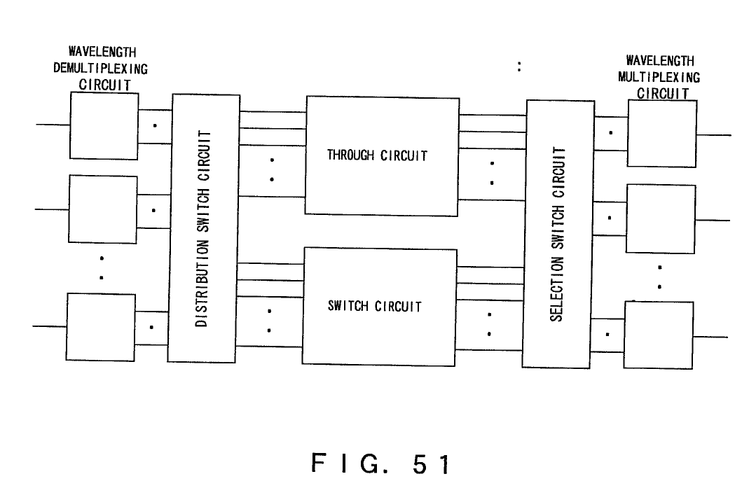

FIG. 51 exemplifies the configuration where distribution units are wavelengths or smaller, and a through circuit and a switch circuit are included.

In this figure, wavelength-multiplexed signals are input to wavelength demultiplexing circuits via a plurality of lines. The wavelength demultiplexing circuits demultiplex the input signals into signals having a single wavelength. The demultiplexed signals are input to a distribution switch circuit. The distribution switch circuit distributes the signals to be passed through to the through circuit in units of wavelengths, and the signals to be switched to the switch circuit in units of wavelengths by determining whether or not the signals are to be either passed through or switched. The signals input to the through circuit are, for example, regenerated by a regenerator circuit, and output to a selection switch circuit unchanged. In the meantime, the switch circuit switches and connects the signals having the single wavelength, and outputs the signals to the selection switch circuit. The selection switch circuit suitably switches and outputs the signals having the single wavelength to a plurality of wavelength multiplexing circuits. The wavelength multiplexing circuits wavelength-multiplex the input signals and output the wavelength-multiplexed signals to respective lines.

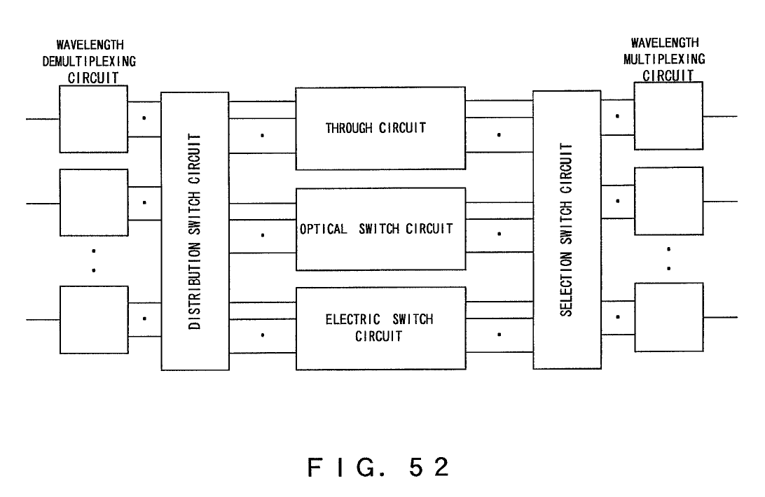

FIG. 52 exemplifies the configuration where the switch circuit shown in the example of FIG. 51 is configured by an optical switch circuit and an electric switch circuit.

In this figure, wavelength-multiplexed signals are input to wavelength demultiplexing circuits via a plurality of lines. The wavelength demultiplexing circuits demultiplex the wavelength-multiplexed signals into signals having a single wavelength, and input the demultiplexed signals to a distribuion switch circuit. The distribution switch circuit determines to which of through, optical switch and electric switch circuits the signals having a single wavelength are to be input, and switches and outputs the signals. The signals input to the through circuit are regenerated by a regenerator included in the through circuit, etc., and input to a selection switch circuit. The signals input to the optical switch circuit are switched and connected in units of wavelengths, and then input to the selection switch circuit. The signals transmitted from the distribution switch circuit to the electric switch circuit are converted into electric signals by an opto-electric converting circuit not shown, and input to the electric switch circuit. The electric switch circuit switches and connects the signals in data units (SDH or SONET frames, IP packets, ATM cells, etc.) smaller than the wavelengths, reassembles the signals in units of wavelengths, and inputs the reassembled signals to an electro-optic converting circuit not shown. The optical signals converted by the electro-optic converting circuit are input to the selection switch circuit.

The optical signals having a single wavelength, which are input from the through circuit, the optical switch circuit, and the electric switch circuit to the selection switch circuit, are switched and output to wavelength multiplexing circuits, which wavelength-multiplex the signals. The wavelength-multiplexed signals are then input to lines.

The optical switch makes switching in units of wavelengths, whereas the electric switch can make switching also in smaller units by electrically separating a signal.

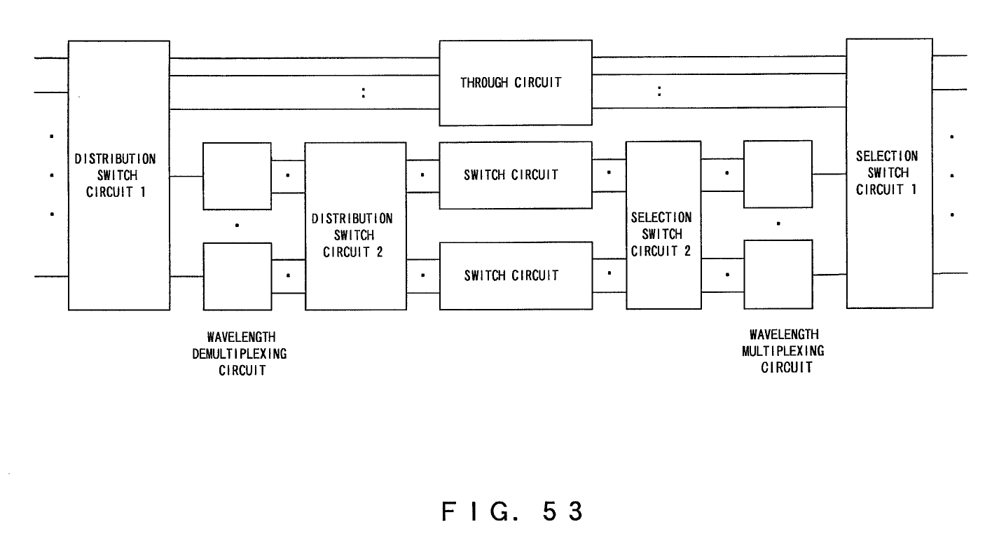

FIG. 53 exemplifies the configuration where the switch unit shown in the example of FIG. 48 is configured by a plurality of independent sub-switch circuits, distribution switch circuits, and a selection switch circuit.

In this figure, wavelength-multiplexed signals are input to a distribution switch circuit 1 via a plurality of lines. The distribution switch circuit 1 determines whether the signals are to be input either to a through circuit or a switch circuit in wavelength-multiplexed signal units, and switches and outputs the signals. After the wavelength-multiplexed signals input to the through circuit are regenerated by a regenerator, etc., they are input to a selection switch circuit 1 unchanged. In the meantime, the wavelength-multiplexed signals to be input to the switch circuit are input to wavelength demultiplexing circuits, which demultiplex the input signals in units of wavelengths. A distribution switch circuit 2 then switches and outputs the demultiplexed signals by determining to which switch circuits the demultiplexed signals are to be input. The switch circuits switch and output the signals having a single wavelength, and input them to wavelength multiplexing circuits. The wavelength multiplexing circuits wavelength-multiplex the input signals, and inputs the wavelength-multiplexed signals to the selection switch circuit 1. The selection switch circuit 1 switches and outputs the wavelength-multiplexed signals to determined lines by determining to which lines the wavelength-multiplexed signals are to be output.

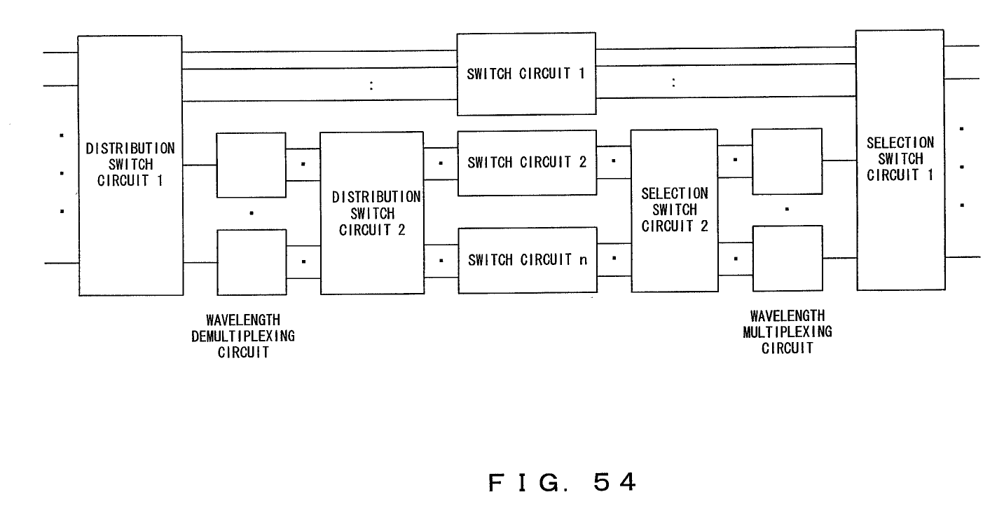

FIG. 54 exemplifies the configuration where the switch unit that makes switching in units of wavelengths or smaller and is shown in the example of FIG. 49 is configured by a plurality of independent sub-switch circuits, distribution switch circuits, and selection switch circuits.

In this figure, wavelength-multiplexed signals are input via a plurality of lines. A distribution switch circuit 1 distributes the signals to be switched in units of wavelength-multiplexed signals to a switch circuit 1, and the signals to be switched in units of wavelengths to wavelength demultiplexing circuits by determining whether the signals are to be switched in units of either wavelengths or wavelength-multiplexed signals. The switch circuit 1 switches and connects the signals in units of wavelength-multiplexed signals, and outputs the signals to a selection switch circuit 1. In the meantime, the signals to be switched in units of wavelengths, which are distributed to the wavelength demultipelxing circuits, are demultiplexed into signals having a single wavelength. The demultiplexed signals are input to a distribution switch circuit 2, which switches and outputs the input signals by determining to which switch circuits 2 through n the signals are to be input, and distributes the signals to suitable ones of the switch circuits 2 through n. The switch circuits 2 through n switch and connect the signals, and output them to a selection switch circuit 2. The selection switch circuit 2 switches and outputs the signals to wavelength-multiplexing circuits by determining the signals that should be multiplexed with. The wavelength multiplexing circuits wavelength-multiplex the input signals having a single wavelength, and inputs the wavelength-multiplexed signals to the selection switch circuit 1. The selection switch circuit 1 switches and outputs the input wavelength-multiplexed signals to suitable lines.

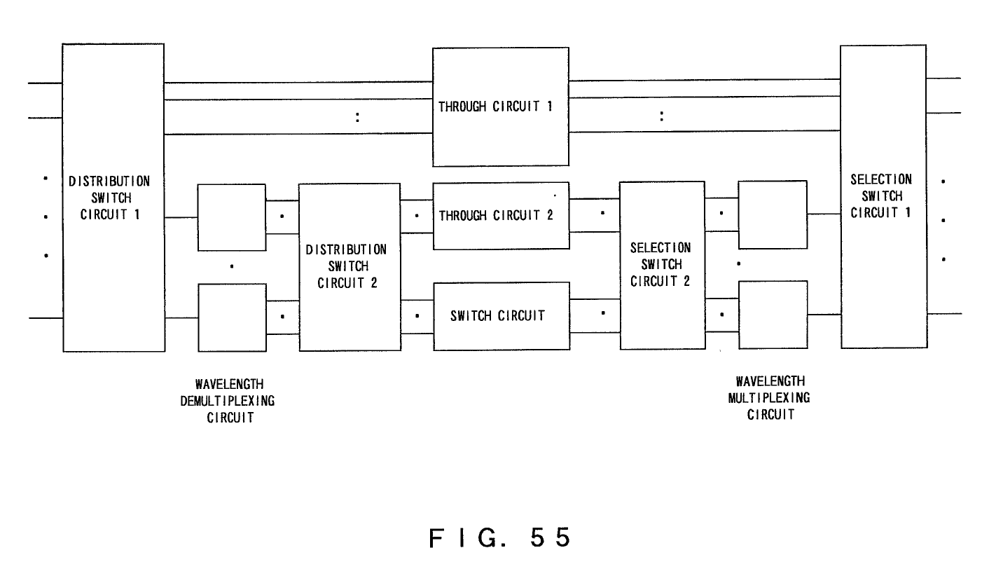

FIG. 55 exemplifies the configuration where one of the sub-switch circuits shown in the example of FIG. 53 is replaced by a through circuit.

In this figure, wavelength-multiplexed signals input from a plurality of lines are input to a distribution switch circuit 1, which classifies the input signals as signals to be passed through in units of wavelength-multiplexed signals and as signals to be processed in units of wavelength, and respectively distributes the signals to a through circuit 1 and wavelength demultiplexing circuits. The through circuit 1 regenerates the wavelength-multiplexed signals unchanged with a regenerator circuit, etc., and inputs the regenerated signals to a selection switch circuit 1. The signals to be processed in units of wavelengths, which are distributed to the wavelength demultiplexing circuits, are demultiplexed into signals having a single wavelength. The demultiplexed signals are input to a distribution switch circuit 2, which classifies the signals as the signals to be passed through and the signals to be switched by a switch circuit, and distributes them to a through circuit 2 and the switch circuit. The through circuit 2 regenerates the signals, passes the signals through unchanged, and outputs them to a selection switch circuit 2. In the meantime, the signals distributed to the switch circuit are switched, connected, and output to a selection switch circuit 2. The selection switch circuit 2 switches and outputs the signals to be wavelength-multiplexed to one wavelength multiplexing circuit. The wavelength multiplexing circuit wavelength-multiplexes the input signals, and outputs the wavelength-multiplexed signal to the selection switch circuit 1. The selection switch circuit 1 switches and outputs the wavelength-multiplexed signals input from the through circuit 1 and the wavelength multiplexing circuits to suitable lines.

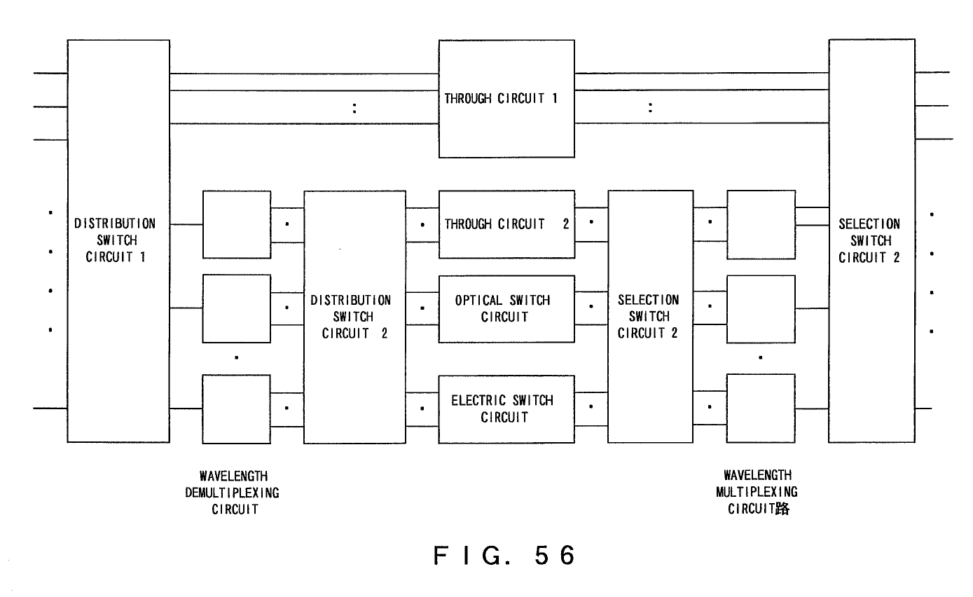

FIG. 56 exemplifies the configuration where one of the sub-switch circuits shown in the example of FIG. 53 is replaced by a through circuit, and the other sub-switch circuit is configured by an optical switch circuit and an electric switch circuit.

In this figure, wavelength-multiplexed signals are input to a distribution switch circuit 1 via a plurality of lines. The distribution switch circuit 1 switches and outputs the wavelength-multiplexed signals by determining whether the signals are either to be passed through in units of wavelength-multiplexed signals or to be processed in units of wavelengths. The signals to be passed through in units of wavelength-multiplexed signals are distributed to a through circuit 1. After the input signals are regenerated by a regenerator, etc., they are input to wavelength demultiplexing circuits unchanged. The signals are then demultiplexed into signals having a single wavelength. A distribution switch circuit 2 receives the demultiplexed signals from the wavelength demultiplexing circuits, and switches and outputs the signals by determining whether the signals are either to be passed through, to be switched unchanged, or to be switched after being converted into electric signals. A through circuit 2 regenerates the signals input in units of wavelengths, and inputs the signals unchanged to a selection switch circuit 2. The optical switch circuit switches the input signals unchanged, and outputs them to the selection switch circuit 2. The electric switch circuit switches the optical signals that are distributed from the distribution switch circuit 2 and converted into electric signals by an opto-electric converting circuit not shown. The electric switch circuit can make switching in smaller data units (SDH or SONET frames, IP packets, ATM cells, etc.) included in a signal of a single wavelength. The signals output from the electric switch circuit are converted into optical signals by an electro-optic converting circuit not shown, and input to the selection switch circuit 2. The selection switch circuit 2 switches and outputs the signals to be wavelength-multiplexed into one signal to one wavelength multiplexing circuit. The wavelength multiplexing circuit wavelength-multiplexes the input signals having a single wavelength, and inputs the wavelength-multiplexed signal to the selection switch circuit 1. The selection switch circuit 1 outputs thus obtained wavelength-multiplexed signals to respective lines.

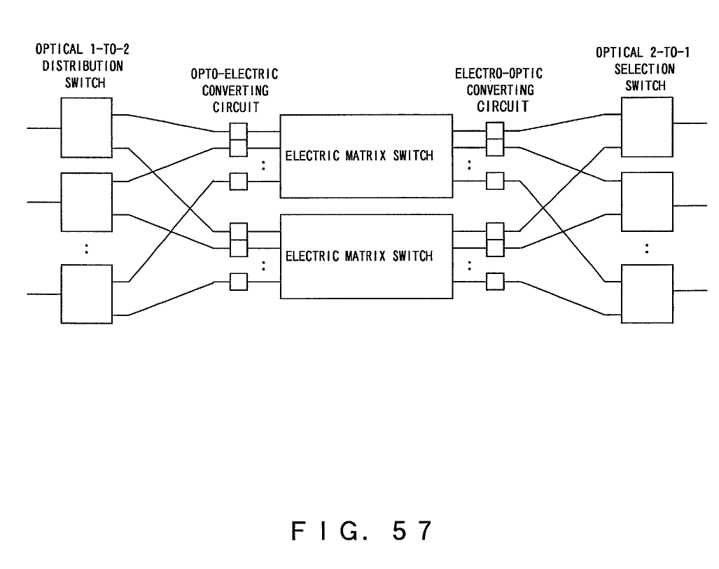

FIG. 57 exemplifies the details of the configuration shown in FIG. 44.

A distribution switch circuit has a configuration such that each input signal is distributed to two sub-switch circuits (electric matrix switches) with a 1-to-2 optical switch. The distributed optical signals are converted into electric signals by opto-electric converting circuits, and input to the electric matrix switches. After the outputs from the electric matrix switches are converted into optical signals by electro-optic converting circuits, the converted signals are output to selection switches. A selection switch is a 2-to-1 optical switch intended to select and output either of the outputs from the two sub-switch circuits (electric matrix switches).

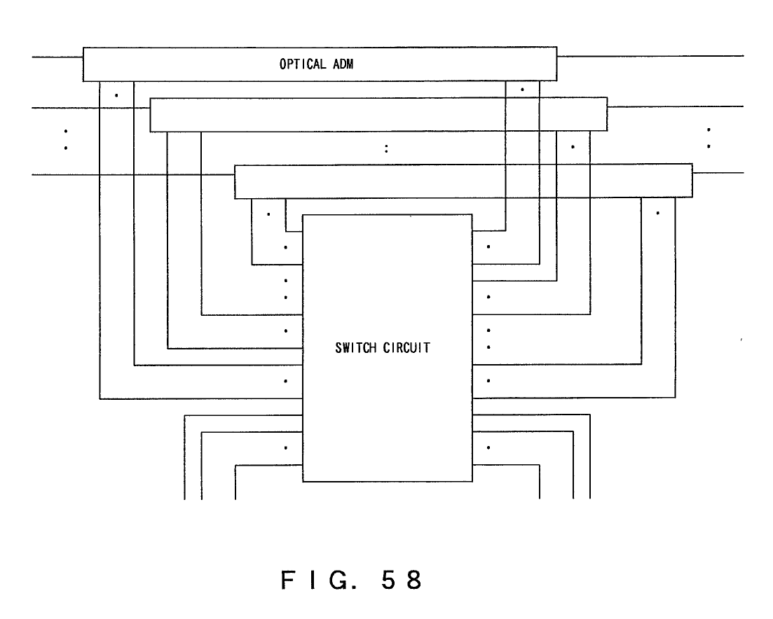

FIG. 58 exemplifies the fundamental configuration of an optical node according to a further preferred embodiment of the present invention.

A plurality of wavelength-multiplexed signals are input to optical ADMs (Add/Drop Muxes). The drop ports of the optical ADMs are connected to a switch circuit. The output ports of the switch circuit are connected to the add ports of the optical ADMs. The switch circuit switches the signals from other devices as well as those from the optical ADMs, and outputs the signals to the optical ADMs or the other devices.

With such a configuration, an optical ADM varies the wavelength of an optical signal to be added/dropped in correspondence with a service change. Accordingly, when a plurality of ports of a switch circuit or a plurality of switch circuits are provided, it is possible to select to which switch circuits or to which port optical signals are to be input, thereby providing an optical node with high serviceability.

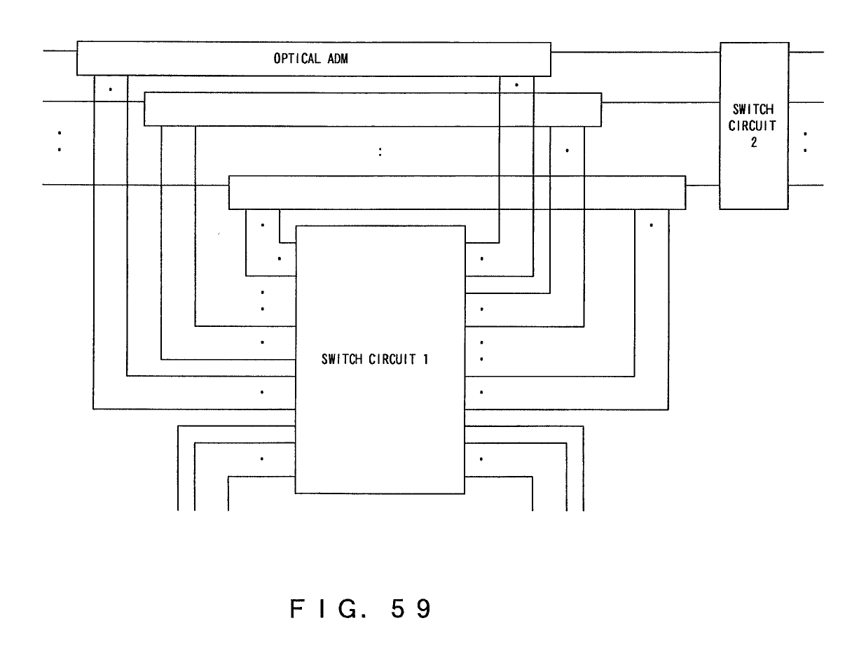

FIG. 59 shows the configuration where the circuit for switching a wavelength-multiplexed signal is arranged in addition to the configuration shown in FIG. 58.

In this figure, an optical signal having a particular wavelength is dropped from a wavelength-multiplexed signal to be input to each optical ADM, and input to a switch circuit 1. The switch circuit 1 switches the signals from the optical ADMs and other devices, and outputs the switched signals to the optical ADMs or the other devices. The optical ADM which has received the signal from the switch circuit 1 adds the received optical signal to a mainstream, and outputs the mainstream. In FIG. 59, the wavelength-multiplexed signals output from the optical ADMs are input to a switch circuit 2. The switch circuit 2 switches lines in units of wavelength-multiplexed signals. In this way, a mainstream can be switched and connected.

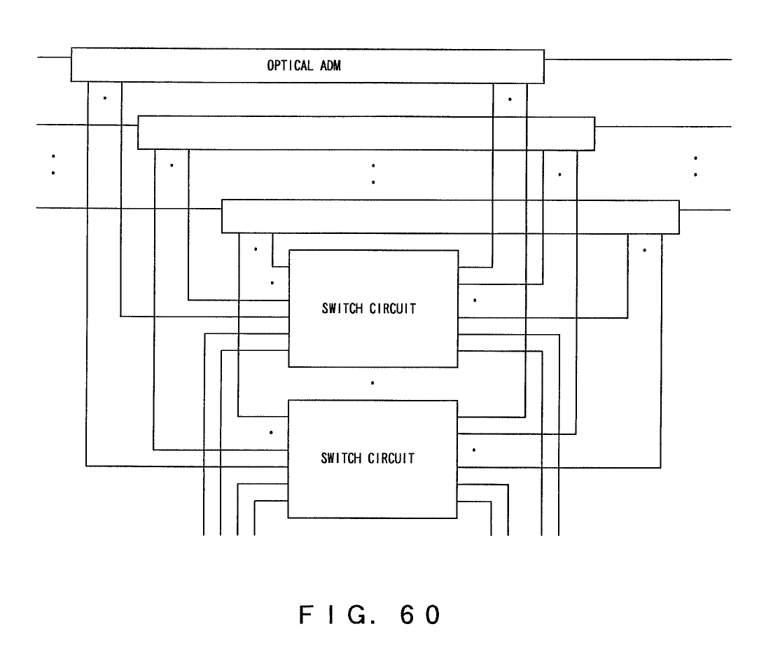

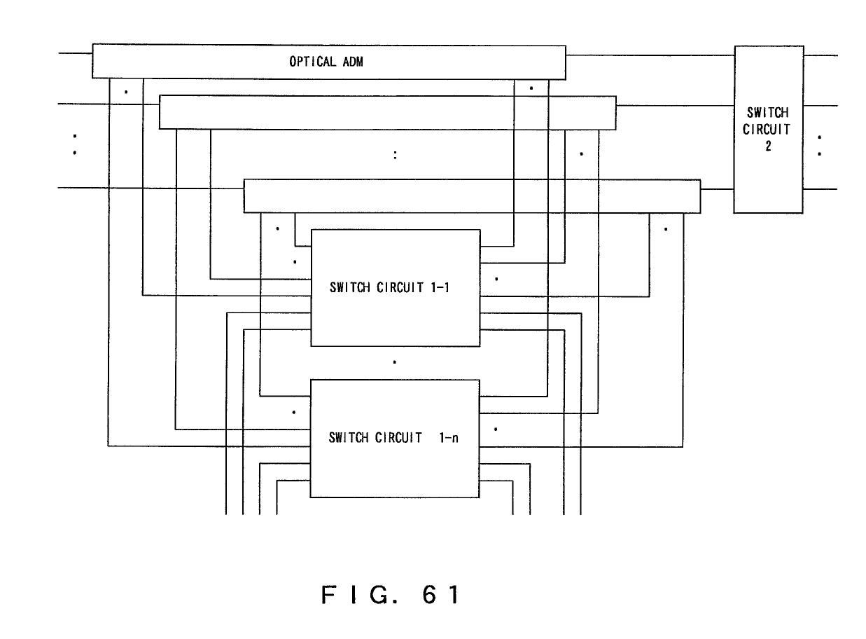

FIGS. 60 and 61 respectively exemplify the modifications of the configurations shown in FIGS. 58 and 59, in which the switch circuits are implemented by a plurality of independent sub-switches.

FIG. 60 shows the configuration where an optical signal dropped by an optical ADM is switched and connected by a plurality of independent switch circuits in the configuration shown in FIG. 58. Because the switch circuit is configured by the plurality of switch circuits as described above, the whole of the switch does not become a complete group switch. However, the scale and the cost of the switch unit can be significantly reduced.

FIG. 61 shows the configuration where an optical signal dropped by an optical ADM is switched and connected by a plurality of independent switch circuits in the configuration shown in FIG. 59. In this case, switch circuits 1-1 through 1-n are intended to make switching and connection in units of wavelengths. A switch circuit 2 is further arranged to make switching in units of wavelength-multiplexed signals, that is, to switch also a mainstream.

In the preferred embodiments shown in FIGS. 58 through 61, the switch circuit(s) connected to the drop port has a capability such as crossconnect, a packet switching, a router, etc.

In the configuration shown in FIG. 58, signal paths are classified into fixed paths (mainstream) and variable paths (add/drop paths), and the path reestablishment required by traffic fluctuations is made by a variable path portion, so that the device scale of the switch unit can be significantly reduced in comparison with the configuration where all paths can be switched. Fixed and variable paths are distributed in units of wavelengths by an optical ADM. The fixed paths are passed through without being dropped, and the variable paths are dropped. Additionally, by using a variable optical ADM which can change a wavelength to be dropped, a wavelength to be rejected (stopped), and a wavelength to be added with a remote operation, the selection of a fixed/variable path can be flexibly changed in units of wavelengths. In FIG. 59, also the switching process in large units can be performed by arranging a switching function on a wavelength-multiplexed signal level. As shown in FIGS. 60 and 61, the switch unit is divided into the independent sub-switches, thereby further reducing the scale of the switch circuit. Furthermore, a variable optical ADM is used, thereby allowing not only the selection of a fixed/variable path, but also a connection of an arbitrary wavelength to an arbitrary sub-switch circuit.

If the numbers of inputs and outputs are respectively N, the device scale of a switch unit becomes approximately N×N in the conventional configuration including the function for establishing the connections between all of inputs and outputs.

In the above described configuration according to the present invention, if n among N inputs are defined to be variable paths, and (N-n) inputs are defined to be fixed paths, the scale of the switch unit becomes n×n. The device scale of the switch unit in these configurations is (n×n)/(N×N) of the conventional configuration.

Furthermore, if the switch unit is divided into m sub-switches, the numbers of inputs and outputs of each sub-switch are respectively n/m. The scale of each sub-switch therefore becomes (n/m)×(n/m). Since the entire switch unit is configured by m sub-switches of this type, its scale becomes (n/m)×(n/m)×m=n×n/m. As a result, the device scale of the entire switch unit results in (1/m)(n×n)/(N×N) of the conventional configuration.

Since the number of switches can be increased according to the number of wavelengths also in these configurations as described above, a cost-effective configuration can be implemented if the number of wavelengths is small, and the scalability according to the number of wavelengths can be implemented. Additionally, a switch unit can be independently expanded, so that a new function keeping abreast with technological advances can be introduced into the switch unit. Furthermore, because sub-switch circuits are mutually independent, sub-switch circuits having different functions can be mixed and included to support a variety of capabilities.

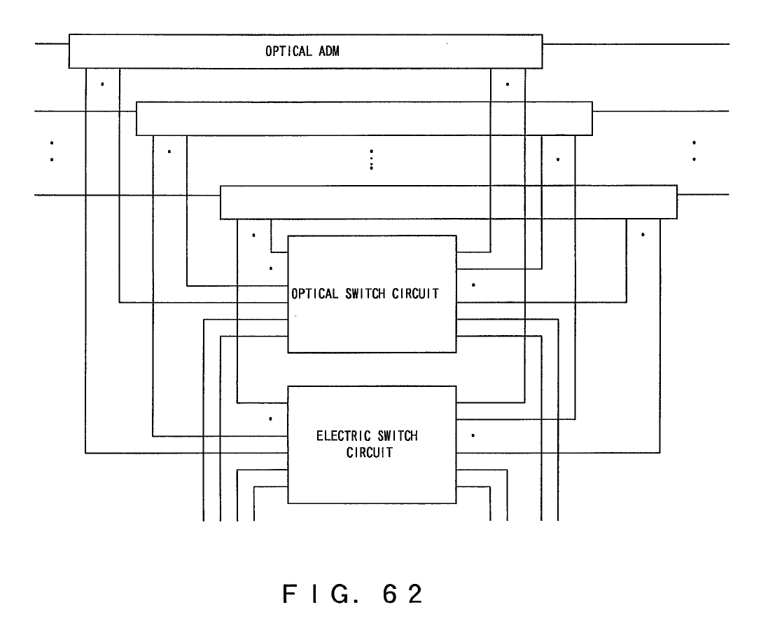

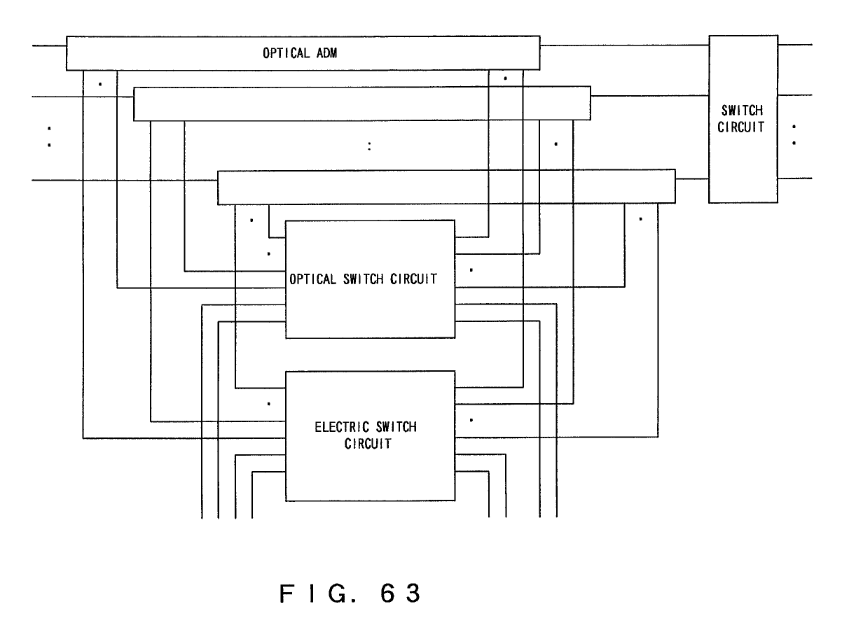

FIGS. 62 and 63 respectively show the configurations where a sub-switch circuit using an electric circuit and a sub-switch circuit using an optical circuit are mixed and included.

In FIG. 62, a signal having a wavelength, which is to be switched and connected in units of wavelengths, is dropped by an optical ADM. An output port is respectively arranged for the optical and the electric switch circuits so as to enable the selection of whether the dropped signal is input either to the optical or the electric switch circuit. The signal input to the optical switch circuit is switched in units of wavelengths, and retransmitted to the optical ADM, which then adds this signal to a through signal. In the meantime, the signal transmitted to the electric switch circuit is converted into an electric signal by an opto-electric converting circuit not shown, switched as an electric signal, reconverted into an optical signal by an electro-optic converting circuit arranged on an output side of the electric switch circuit, and transmitted to the optical ADM.

FIG. 63 exemplifies the configuration where an electric switch is introduced in the configuration shown in FIG. 61.

In this figure, an optical signal from an optical ADM is switched unchanged similar to FIG. 62, and at the same time, an optical signal is switched by an electric switch circuit after being converted into an electric signal, which is reconverted into an optical signal after being switched, and transmitted to the optical ADM. In this case, switching is made in units of wavelengths or smaller in the optical switch and the electric switch circuits. By further arranging a switch circuit, switching can be made in units of wavelength-multiplexed signals.

As described above, in the configurations shown in FIGS. 62 and 63, the switching functions in different crossconnect units can be mixed and included. For example, the optical switch circuit makes a crossconnection in units of wavelengths (2.4 Gbps, 10 Gbps, etc.), whereas the electric switch circuit makes a crossconnection in units (150 Mbps, 600 Mbps, etc.) smaller than wavelengths by separating a signal with the electric circuit.

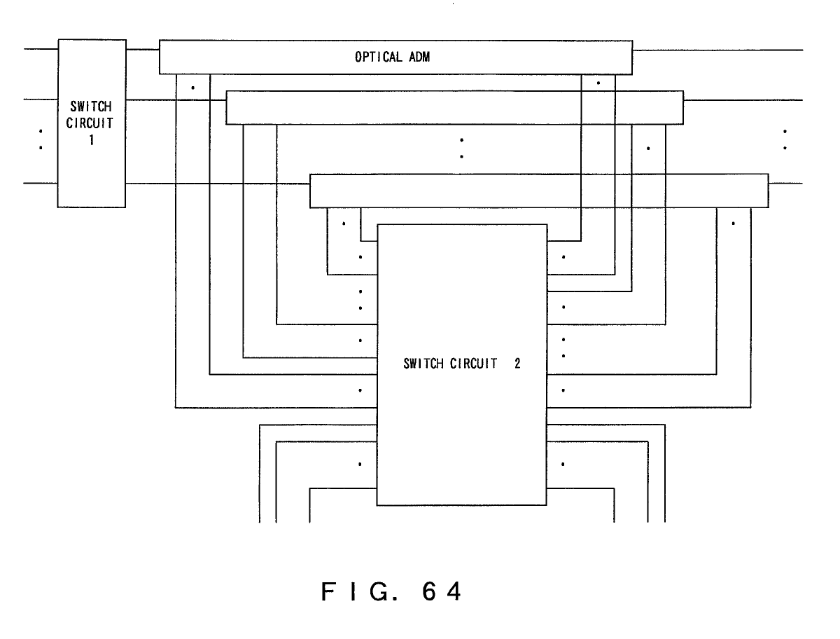

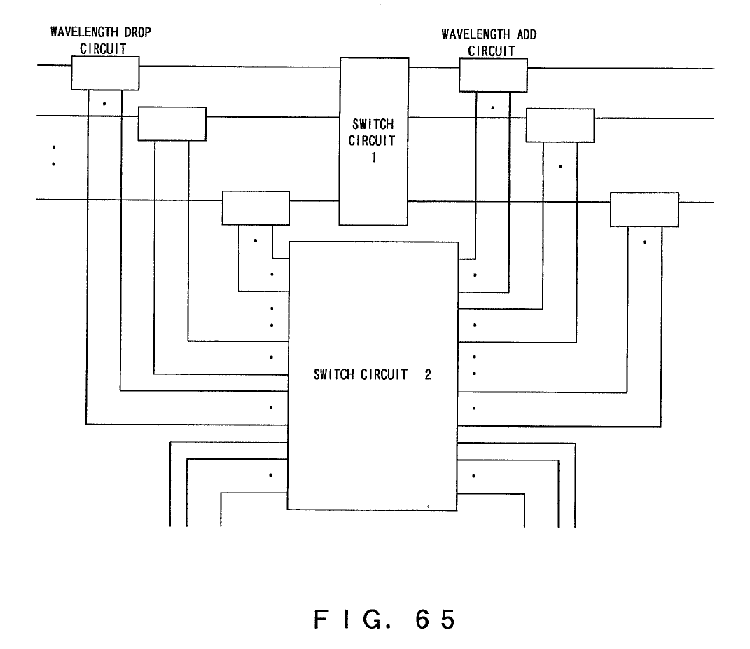

FIGS. 64 and 65 show the configurations where the circuit that makes switching in units of wavelength-multiplexed signals is respectively arranged in an input portion and a middle stage portion of an optical ADM in the configuration shown in FIG. 63.

In FIG. 64, a switch circuit 1 which makes switching in units of wavelength-multiplexed signals is arranged on an input side of the optical ADM. In this figure, switching is made in units of wavelength-multiplexed signals before the optical ADM and a switch circuit 2 make switching in units of wavelengths.

In FIG. 65, a switch circuit 1 which makes switching in units of wavelength-multiplexed signals is arranged between a wavelength drop circuit and a wavelength add circuit of an optical ADM. In this case, the signal which is switched by a switch circuit 2 in units of wavelengths is not switched by the switch circuit 1. Namely, in the configuration shown in FIG. 65, a through signal being a mainstream is switched by the switch circuit 1. Accordingly, an actual through signal is only a signal the route of which is not changed by the switch circuit 1.

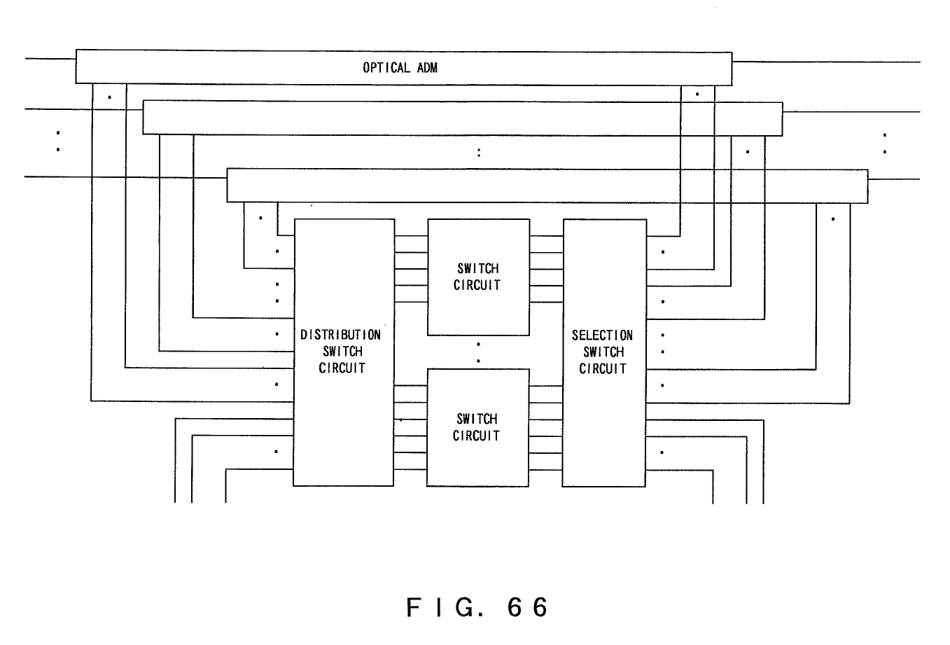

FIG. 66 exemplifies the configuration where a switch unit is configured by a plurality of independent sub-switch circuits, a distribution switch circuit, and a selection switch circuit.

In FIG. 66, the sub-switches (switch circuits) can be selected by the distribution switch and the selection switch circuits unless optical ADMs are not of a variable type.

If this system is a system where a wavelength added/dropped by the optical ADMs is fixed, it becomes impossible to select to which of the sub-switch circuits a signal is to be input. Accordingly, the distribution switch circuit is arranged at the stage preceding the sub-switch circuits, and the selection switch circuit is arranged at the stage succeeding the sub-switch circuits. The distribution switch circuit selects a sub-switch circuit depending on how to switch a signal input to the distribution switch circuit itself. The selection switch circuit selects and outputs the signal, which is output after being switched and connected by the switch circuit, by determining to which optical ADM the signal is to be input as an add signal.

As referred to also in the explanation of FIG. 58, not only the optical ADMs but also a different device inputs a signal to the switch circuits which make switching in units of wavelengths also in the configurations shown in FIGS. 59 through 66, and the signal from the different device is transmitted to any of the optical ADMs or the signal from any of the optical ADM is transmitted to the different device in some cases.

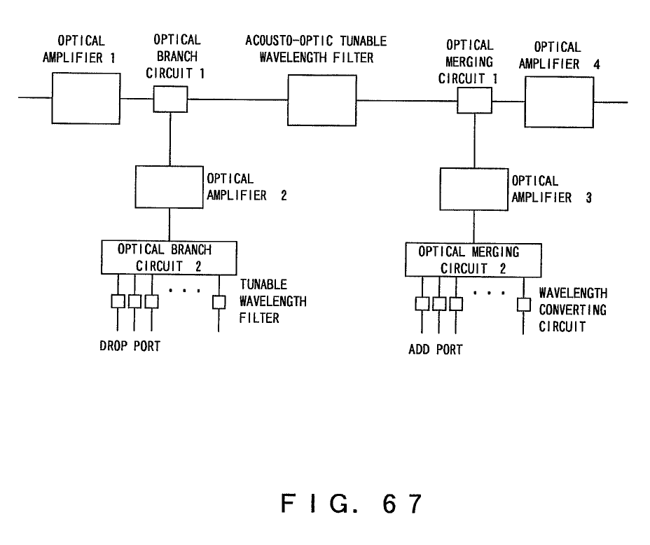

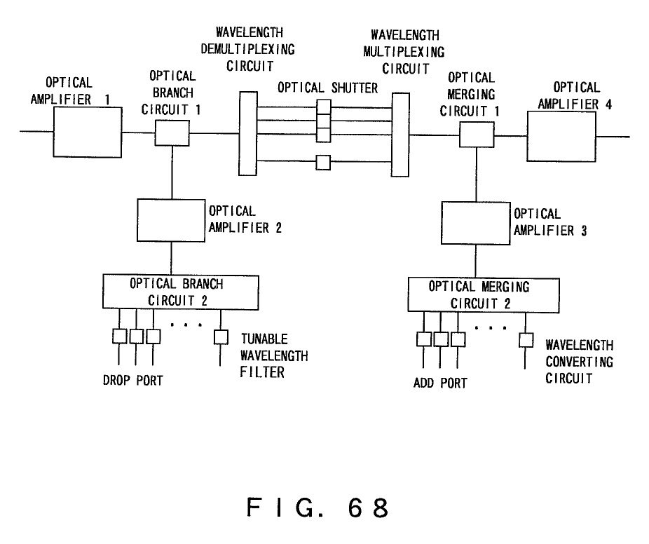

FIGS. 67 and 68 exemplify the configurations of an optical ADM.

A signal drop circuit is configured by an optical branch circuit, and a tunable filter for selecting one wavelength from a wavelength-multiplexed signal, whereas a signal add circuit is configured by an optical wavelength converting circuit and an optical merging circuit.

FIG. 67 shows an example where a wavelength rejection filter is configured by an acousto-optic tunable wavelength filter, whereas FIG. 68 shows an example where a wavelength rejection filter is configured by a wavelength demultiplexing circuit, an optical shutter, and a wavelength multiplexing circuit. In these configurations, a wavelength to be added/dropped can be flexibly changed.

In FIG. 67, a wavelength-multiplexed signal is first input to an optical amplifier 1 so as to compensate for its transmission loss. The amplified optical wavelength-multiplexed signal is then input to an optical branch circuit 1. The optical branch circuit 1 branches the wavelength-multiplexed signal, which is then amplified by an optical amplifier 2 to compensate for the branch loss caused by the optical branch circuit 1. Next, the wavelength-multiplexed signal that is amplified by the optical amplifier 2 is input to an optical branch circuit 2, and converted into signals having a single wavelength. Only a signal having a required wavelength is passed by the tunable wavelength filter, so that a signal having an arbitrary wavelength is dropped.

In the meantime, on the add side, the wavelengths of an input signal are converted into signals having wavelengths suitable for wavelength multiplexing by a wavelength converting circuit. The optical signals having the single wavelength are merged by an optical merging circuit 2, and amplified by an optical amplifier 3. This amplification is intended to compensate for the loss caused by the optical merging circuit 1 at the next stage beforehand.

Additionally, the acousto-optic tunable wavelength filter is intended to pass the signals other than a signal having a dropped wavelength of a wavelength-multiplexed signal transmitted from the optical branch circuit 1, and to stop the signal having the dropped wavelength from passing through (wavelength rejection).

The signals passed through the acousto-optic tunable wavelength filter and the signal transmitted from the optical amplifier 3 are merged by the optical merging circuit 1, and lastly, the power of the optical signal is amplified to stand a long-distance transmission, and output by an optical amplifier 4.

In FIG. 68, a wavelength demultiplexing circuit, an optical shutter, and a wavelength multiplexing circuit replace the acousto-optic tunable wavelength filter shown in FIG. 67. Since the operations of the other portions are the same as those in FIG. 67, their explanations are omitted here.

The wavelength-multiplexed signal transmitted from an optical branch circuit 1 is input to the wavelength demultiplexing circuit, and demultiplexed into signals having a single wavelength. The optical shutter is arranged on a transmission line of each of the signals. The optical shutter closes the transmission line of the signal having the same wavelength as that of the signal dropped by a tunable wavelength filter so as to prevent the signal having that wavelength from passing through (wavelength rejection). Optical signals passing through the transmission lines which are not closed by the optical shutter are input to a wavelength multiplexing circuit, and wavelength-multiplexed. The wavelength-multiplexed signal from the wavelength multiplexing circuit is merged with an add signal by an optical merging circuit 1 and transmitted via an optical amplifier 4.

In the explanations of the above described preferred embodiments, switching and connection, the switching, and crossconnection are used almost in the same sense.

Additionally, the optical switches (the optical matrix switch, the switch circuit, the optical switch circuit, the WDM switch circuit, and the wavelength switch circuit), the electric switches (the electric matrix switch, the switch circuit, and the electric switch circuit), the wavelength demultiplexing circuits, the wavelength multiplexing circuits, the opto-electric converting circuits, the electro-optic converting circuits, and the regenerator circuits are known. Therefore, their details are not referred to in this specification. For the details, please see the following documents.

Optical Switches

(1) L. Y. Lin, et al., “High-density Connection-symmetric Free-space Micromachined Polygon Optical Crossconnects Low Loss for WDM Networks”, OFC' 98, PD24, 1998

(2) Toshio Shimoe, et al, “A Path-independent-insertion-Loss Optical Space Switching Nework”, ISS' 87, C12.2, 1987

Electric Switches

(1) K. D. Pedrotti, et al., “WEST 120-Gbps 3×3 wavelength-division multiplexed cross-connect”, OFC' 98, TuJ7, 1998

Wavelength Demultiplexing and Multiplexing Circuits

(1) K. Okamoto et al., “Arrayed-waveguide grating multiplexer with flat spectral response”, OPTICS LETTERS, Vol. 20, No. 1, pp.43-45, 1995

Opto-Electric and Electro-Optic Converting Circuits and Regenerator Circuits

(1) M. Ushirozawa, et al., “Bit-rate-Independent SDH/SONET Regenerator for Optical Network”, ECOC' 97, Vol. 4, pp. 25-28, 1997

Up to this point, the particular configurations of the preferred embodiments according to the present invention have been described. However, it can be easily understood by a person having ordinary skill in the art that other combinations or modifications of these configurations can be easily made.

According to the present invention, the device scale and the cost of a large-capacity optical node system can be significantly reduced, and the upgradability according to the number of wavelengths can be ensured. Furthermore, a large-capacity optical node system that flexibly supports a variety of functions can be realized by mixing and including switches the granuralities (switching units) of which are different, switches having different functions such as a crossconnect switch, and a packet switch, and the like.

What is claimed is:

1. An apparatus, comprising:
a unit inputting a part of a plurality of input optical signals, outputting a part of a plurality of output optical signals, and isolating the part of a plurality of input optical signals and the output optical signals so as to switch and connect.

2. The apparatus according to claim 1, further comprising:
a wavelength demultiplexing unit demultiplexing an input wavelength-multiplexed signal into optical signals having a single wavelength; and
a wavelength multiplexing unit multiplexing the signals having the single wavelengths, which are switched and connected by said unit, into a wavelength-multiplexed signal.

3. The apparatus according to claim 3, wherein
said unit, to which optical signals are input, makes switching and connection in units of optical signals.

4. The apparatus according to claim 1, further comprising:
an electro-optic converting unit converting an electric signal into an optical signal; and
an opto-electric converting unit converting an optical signal into an electric signal, wherein said unit switches and connects the electric signals.

5. The apparatus according to claim 1, further comprising:
an electro-optic converting unit converting an electric signal into an optical signal; and
an opto-electric converting unit converting an optical signal into an electric signal,
wherein said unit comprises at least one optical switch unit and at least one electric switch unit, both of which independently switch input signals to output signals, and
wherein said opto-electric converting unit inputs an electric signal to said electric switch unit and said electro-optic converting unit receives an electric signal from said electric switch unit and outputs an optical signal.

6. The apparatus according to claim 1, wherein
at least some of a plurality of units make switching and connection in units of wavelength-multiplexed signals.

7. The apparatus according to claim 1, wherein
at least some of a plurality of units are through units which pass signals through unchanged without switching and connecting the signals.

8. The apparatus according to claim 1, further comprising:
a distribution switch unit distributing signals to any of a plurality of units; and
a selection switch unit selects and outputs signals output from the plurality of units.

9. The apparatus according to claim 1, comprising
a plurality of optical ADMs, wherein a dropped signal from the optical ADMs is input to said unit, and an output from said unit is added to the optical ADMs.

10. A signal switching and connection method for use in an optical node device having pluralities of signal inputs and outputs, comprising:
(a) inputting some of all of signals that can be input to the optical node device; and
(b) switching, connecting, and outputting some of all of signals that can be output from the optical node device, wherein
all of the signals are switched and connected as a non-complete group switch by performing (a) and (b) for all of the signals input to the optical node device.

11. The signal switching and connection method according to claim 10, wherein
some of all of the signals input to the optical node device are passed through without being switched and connected.

12. The signal switching and connection method according to claim 10, wherein
some of all of the signals input to the optical node device are switched and connected in units of wavelength-multiplexed signals.

13. The signal switching and connection method according to claim 10, further comprising:
(c) passing others of all of the signals input to the optical node device through without switching and connecting the others of all of the signals:
(d) switching and connecting still others of all of the signals input to the optical node device in units of wavelength-multiplexed signals; and
(e) selecting any of (b), (c), and (d) for all of the signals input to the optical node device.

14. The signal switching and connection method according to claim 10, wherein
a signal for which the switching and connection are made is selected by an optical ADM.
